(19) United States
(12) Patent Application Publication
(10) Pub. No.: US 2018/0131943 A1
(43) Pub. Date: May 10, 2018

(54) METHOD FOR PROCESSING VIDEO SIGNAL AND DEVICE FOR SAME

(71) Applicant: LG Electronics Inc., Seoul (KR)

(72) Inventors: Naeri PARK, Seoul (KR); Seungwook PARK, Seoul (KR); Jaehyun LIM, Seoul (KR); Chulkeun KIM, Seoul (KR); Jungdong SEO, Seoul (KR); Sunmi YOO, Seoul (KR); Junghak NAM, Seoul (KR)

(73) Assignee: LG Electronics Inc., Seoul (KR)

(21) Appl. No.: 15/570,139

(22) PCT Filed: Apr. 27, 2016
(86) PCT No.: PCT/KR2016/004384

§ 371 Date: Oct. 27, 2017

Related U.S. Application Data
(60) Provisional application No. 62/153,486, filed on Apr. 27, 2015.

(51) Int. Cl. H04N 19/159; H04N 19/139; H04N 19/126; H04N 19/122; H04N 19/96; H04N 19/109

(52) U.S. Cl. CPC H04N 19/159; H04N 19/139; H04N 19/109; H04N 19/122; H04N 19/96; H04N 19/126

(57) ABSTRACT

The present invention relates to method and device for decoding a bitstream for a video signal, the method comprising the steps of: obtaining a predicted value for a current block on the basis of a moving vector of the current block; and restoring the current block on the basis of the predicted value for the current block. In case a particular condition is satisfied, the step of obtaining the predicted value for the current block comprises: obtaining of a first predicted value by applying, to an area located at a particular boundary of the current block, a motion vector of a neighboring block adjacent to the area; obtaining of a second predicted value by applying a motion vector of the current block to the area; and obtaining of a weighted sum by applying a first weight to the first predicted value and by applying a second weight to the second predicted value.

### TECHNICAL FIELD

The present invention relates to video processing, and more specifically, relates to a method and apparatus for processing a video signal using inter prediction.

### BACKGROUND ART

In accordance with the rapid development of a digital video processing technology, a digital multimedia service using various media such as high-definition digital broadcasting, digital multimedia broadcasting, internet broadcasting and the like has been activated. As the high-definition digital broadcasting becomes common, various service applications have been developed and high-speed video processing techniques for video images of high quality and high definition are required. To this end, standards for coding video signals such as H.265/HEVC (High Efficiency Video Coding) and H.264/AVC (Advanced Video Coding) have been actively discussed.

### DISCLOSURE OF THE INVENTION

### Technical Task

An object of the present invention is to provide a method for efficiently processing a video signal and an apparatus for the same.

Another object of the present invention is to reduce a prediction error and improve coding efficiency by performing inter prediction by applying motion information of a neighboring block.

A further object of the present invention is to reduce a prediction error and improve coding efficiency by smoothing a predictor of a current block using a predictor of a neighboring block.

It will be appreciated by persons skilled in the art that the objects that could be achieved with the present invention are not limited to what has been particularly described hereinabove and the above and other objects that the present invention could achieve will be more clearly understood from the following detailed description.

### Technical Solutions

In a first aspect of the present invention, provided herein is a method for decoding a bitstream for a video signal by a decoding apparatus, the method comprising: obtaining a predictor for a current block based on a motion vector of the current block; and reconstructing the current block based on the predictor for the current block, wherein when a specific condition is satisfied, obtaining the predictor for the current block includes: obtaining a first predictor by applying, to an area located at a specific boundary of the current block, a motion vector of a neighboring block adjacent to the area, obtaining a second predictor by applying the motion vector of the current block to the area, and obtaining a weighted sum by applying a first weight to the first predictor and applying a second weight to the second predictor.

In a second aspect of the present invention, provided herein is a decoding apparatus configured to decode a bitstream for a video signal, the decoding apparatus comprising a processor, wherein the processor is configured to: obtain a predictor for a current block based on a motion vector of the current block, and reconstruct the current block based on the predictor for the current block, wherein when a specific condition is satisfied, obtaining the predictor for the current block includes: obtaining a first predictor by applying, to an area located at a specific boundary of the current block, a motion vector of a neighboring block adjacent to the area, obtaining a second predictor by applying the motion vector of the current block to the area, and obtaining a weighted sum by applying a first weight to the first predictor and applying a second weight to the second predictor.

Preferably, when the specific boundary corresponds to a left boundary or an upper boundary of the current block, the first predictor is obtained by applying a motion vector of a spatial neighboring block of the current block, and when the specific boundary corresponds to a right boundary or a lower boundary of the current block, the first predictor is obtained by applying a motion vector of a temporal neighboring block of the current block.

Preferably, the spatial neighboring block corresponds to a neighboring block located at an opposite side of the area with respect to the specific boundary within a picture including the current block, and the temporal neighboring block corresponds to a block located at a position corresponding to the current block within a picture different from the picture including the current block.

Preferably, the first weight is configured to have a higher value as closer to the specific boundary, and the second weight is configured to have a lower value as closer to the specific boundary.

Preferably, the area corresponds to a 2×2 block or a 4×4 block.

Preferably, the specific condition includes a condition that the motion vector of the current block is different from the motion vector of the neighboring block, and a condition that a difference between the motion vector of the current block and the motion vector of the neighboring block is smaller than a threshold and a reference picture of the current block is equal to a reference picture of the neighboring block.

Preferably, flag information indicating whether prediction using the weighted sum is applied to the current block is received through a bitstream, and the specific condition includes a condition that the flag information indicates that the prediction using the weighted sum is applied to the current block.

### Advantageous Effects

According to the present invention, a video signal can be efficiently processed.

According to the present invention, a prediction error can be reduced and coding efficiency can be improved by performing inter prediction by applying motion information of a neighboring block.

According to the present invention, a prediction error can be reduced and coding efficiency can be improved by smoothing a predictor of a current block using a predictor of a neighboring block.

It will be appreciated by persons skilled in the art that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention.

FIG. 1 illustrates an encoding procedure.

FIG. 2 illustrates a decoding procedure.

FIG. 3 illustrates a flow chart for a method of partitioning a coding tree block (CTB).

FIG. 4 illustrates an example of partitioning a CTB by a quadtree scheme.

FIG. 5 illustrates an example of syntax information and operations for a coding block.

FIG. 6 illustrates an example of syntax information and operations for a transform tree.

FIG. 7 illustrates boundaries of prediction blocks and samples restored using inter prediction.

FIG. 8 illustrates an inter prediction method according to the present invention.

FIG. 9 illustrates neighboring blocks according to the present invention.

FIG. 10 illustrates a relationship between the specific area of the current block and the neighboring block.

FIG. 11 illustrates weights according to the present invention.

FIG. 12 illustrates areas where smoothing is applied.

FIG. 13 illustrates smoothing factors according to the present invention.

FIG. 14 illustrates weights and smoothing factors according to the present invention.

FIG. 15 illustrates a block diagram of a video processing apparatus to which the present invention can be applied.

### BEST MODE FOR INVENTION

A technology described in the following can be used for an image signal processing apparatus configured to encode and/or decode a video signal. Generally, a video signal corresponds to an image signal or a sequence of pictures capable of being recognized by eyes. Yet, in the present specification, the video signal can be used for indicating a sequence of bits representing a coded picture or a bit stream corresponding to a bit sequence. A picture may indicate an array of samples and can be referred to as a frame, an image, or the like. More specifically, the picture may indicate a two-dimensional array of samples or a two-dimensional sample array. A sample may indicate a minimum unit for constructing a picture and may be referred to as a pixel, a picture element, a pel, or the like. The sample may include a luminance (luma) component and/or a chrominance (chroma, color difference) component. In the present specification, coding may be used to indicate encoding or may commonly indicate encoding/decoding.

A picture may include at least one or more slices and a slice may include at least one or more blocks. The slice can be configured to include the integer number of blocks for purposes such as parallel processing, resynchronization of decoding when a bit stream is damaged due to data loss, and the like. Each slice can be independently coded. A block may include at least one or more samples and may indicate an array of samples. A block may have a size equal to or a less than a size of a picture. A block may be referred to as a unit. A currently coded picture may be referred to as a current picture and a block currently being coded may be referred to as a current block. There may exist various block units constructing a picture. For example, in case of ITU-T H.265 standard (or High Efficiency Video Coding (HEVC) standard), there may exist such a block unit as a coding tree block (CTB) (or a coding tree unit (CTU)), a coding block (CB) (or a coding unit (CU)), a prediction block (PB) (or a prediction unit (PU)), a transform block (TB) (or a transform unit (TU)), and the like.

The coding tree block corresponds to the most basic unit for constructing a picture and can be divided into coding blocks of a quad-tree form to improve coding efficiency according to texture of a picture. The coding block may correspond to a basic unit for performing coding and intra-coding or inter-coding can be performed in a unit of the coding block. The intra-coding is to perform coding using intra prediction and the intra prediction is to perform prediction using samples included in the same picture or slice. The inter-coding is to perform coding using inter prediction and the inter prediction is to perform prediction using samples included in a picture different from a current picture. A block coded using the intra-coding or coded in an intra prediction mode may be referred to as an intra block, and a block coded using the inter-coding or coded in an inter prediction mode may be referred to as an inter block. And, a coding mode using intra prediction can be referred to as an intra mode, and a coding mode using inter prediction can be referred to as an inter mode.

The prediction block may correspond to a basic unit for performing prediction. Identical prediction can be applied to a prediction block. For example, in case of the inter prediction, the same motion vector can be applied to one prediction block. The transform block may correspond to a basic unit for performing transformation. The transformation may correspond to an operation of transforming samples of a pixel domain (or a spatial domain or a time domain) into a conversion coefficient of a frequency domain (or a transform coefficient domain), or vice versa. In particular, an operation of converting a conversion coefficient of the frequency domain (or transform coefficient domain) into samples of the pixel domain (or spatial domain or time domain) can be referred to as inverse transformation. For example, the transformation may include discrete cosine transform (DCT), discrete sine transform (DST), a Fourier transform, and the like.

In the present specification, a coding tree block (CTB) may be interchangeably used with a coding tree unit (CTU), a coding block (CB) may be interchangeably used with a coding unit (CU), a prediction block (PB) may be interchangeably used with a prediction unit (PU), and a transform block (TB) may be interchangeably used with a transform unit (TU).

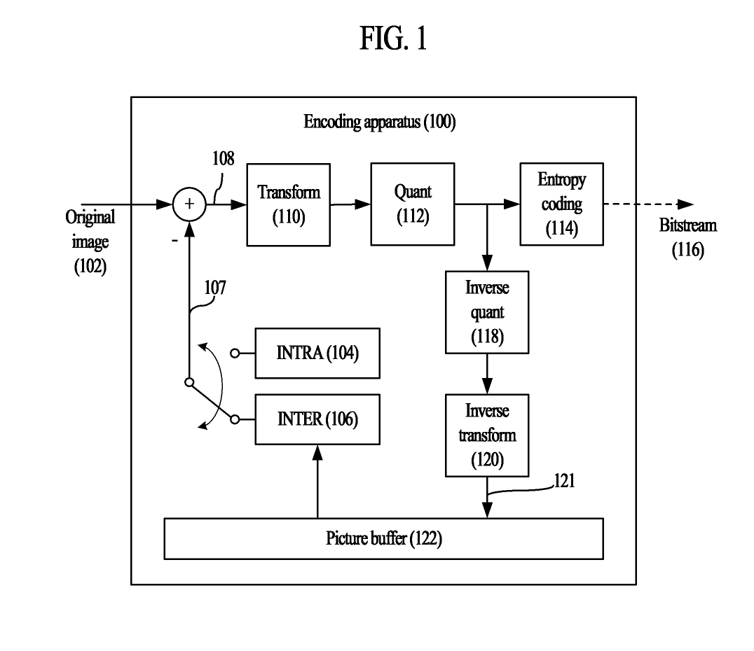

FIG. 1 illustrates an encoding procedure.

An encoding apparatus 100 receives an input of an original image 102, performs encoding on the original image, and outputs a bit stream 114. The original image 102 may correspond to a picture. Yet, in the present example, assume that the original image 102 corresponds to a block for constructing a picture. For example, the original image 102 may correspond to a coding block. The encoding apparatus 100 can determine whether the original image 102 is coded in intra mode or inter mode. If the original image 102 is included in an intra picture or a slice, the original image 102 can be coded in the intra mode only. However, if the original image 102 is included in an inter picture or a slice, for example, it is able to determine an efficient coding method in consideration of RD (rate-distortion) cost after the intra-coding and the inter-coding are performed on the original image 102.

In case of performing the intra-coding on the original image 102, the encoding apparatus 100 can determine an intra-prediction mode showing RD optimization using reconstructed samples of a current picture including the original image 102 (104). For example, the intra-prediction mode can be determined by one selected from the group consisting of a direct current (DC) prediction mode, a planar prediction mode and an angular prediction mode. The DC prediction mode corresponds to a mode in which prediction is performed using an average value of reference samples among reconstructed samples of a current picture, the planar prediction mode corresponds to a mode in which prediction is performed using bilinear interpolation of reference samples, and the angle prediction mode corresponds to a mode in which prediction is performed using a reference sample located in a specific direction with respect to the original image 102. The encoding apparatus 100 can output a predicted sample or a prediction value (or predictor) 107 using the determined intra prediction mode.

When the inter-coding is performed on the original image 102, the encoding apparatus 100 performs motion estimation (ME) using a reconstructed picture included in a (decoded) picture buffer 122 and may be then able to obtain motion information (106). For example, the motion information can include a motion vector, a reference picture index, and the like. The motion vector may correspond to a two-dimensional vector that provides an offset from a coordinate of the original image 102 to a coordinate in a reference picture in a current picture. The reference picture index may correspond to an index for a list of reference pictures (or a reference picture list) used for inter prediction among the reconstructed pictures stored in the (decoded) picture buffer 122. The reference picture index indicates a corresponding reference picture. The encoding apparatus 100 can output a predicted sample or a predicted value 107 using the obtained motion information.

Subsequently, the encoding apparatus 100 can generate a residual data 108 from a difference between the original image 102 and the predicted sample 107. The encoding apparatus 100 can perform a transformation on the generated residual data 108 (110). For example, Discrete Cosine Transform (DCT), Discrete Sine Transform (DST), and/or wavelet transform can be applied for the transformation. More specifically, it may use an integer-based DCT having a size of 4×4 to 32×32 and 4×4, 8×8, 16×16, and 32×32 transforms can be used. The encoding apparatus 100 performs transformation 110 to obtain transform coefficient information.

The encoding apparatus 100 quantizes the transform coefficient information to generate quantized transform coefficient information (112). Quantization may correspond to an operation of scaling a level of the transform coefficient information using a quantization parameter (QP). Hence, the quantized transform coefficient information may be referred to as scaled transform coefficient information. The quantized transform coefficient information can be output as a bit stream 116 via entropy coding 114. For example, the entropy coding 114 can be performed based on fixed length coding (FLC), variable length coding (VLC), or arithmetic coding. More specifically, it may apply context adaptive binary arithmetic coding (CABAC) based on arithmetic coding, Exp-Golomb coding based on variable length coding, and fixed length coding.

And, the encoding apparatus 100 performs inverse quantization 118 and inverse transformation 120 on the quantized transform coefficient information to generate a reconstructed sample 121. Although it is not depicted in FIG. 1, in-loop filtering can be performed on a reconstructed picture after obtaining the reconstructed picture by acquiring the reconstructed sample 121 for a picture. For the in-loop filtering, for example, it may apply a deblocking filter, a sample adaptive offset (SAO) filter. Subsequently, the reconstructed picture 121 is stored in the picture buffer 122 and can be used for encoding a next picture.

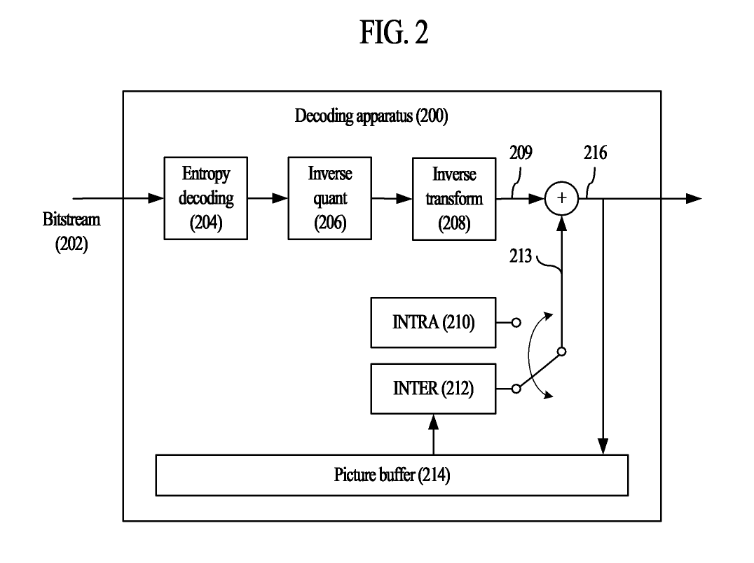

FIG. 2 illustrates a decoding procedure.

A decoding apparatus 200 receives a bit stream 202 and can perform entropy decoding 204. The entropy decoding 204 may correspond to a reverse operation of the entropy coding 114 mentioned earlier in FIG. 1. The decoding apparatus 200 can obtain data and (quantized) transform coefficient information necessary for decoding by including prediction mode information, intra prediction mode information, motion information, and the like through the entropy decoding 204. The decoding apparatus 200 can generate a residual data 209 by performing inverse quantization 206 and inverse transformation 208 on the obtained transform coefficient information.

The prediction mode information obtained through the entropy decoding 204 can indicate whether a current block is coded in intra mode or inter mode. If the prediction mode information indicates the intra mode, the decoding apparatus 200 can obtain a prediction sample (or prediction value) 213 from reconstructed samples of a current picture based on the intra prediction mode obtained through the entropy decoding 204 (210). If the prediction mode information indicates the inter mode, the decoding apparatus 200 can obtain a prediction sample (or prediction value) 213 from a reference picture stored in the picture buffer 214 based on the motion information obtained through the entropy decoding 204 (212).

The decoding apparatus 200 can obtain a reconstructed sample 216 for the current block using the residual data 209 and the prediction sample (or prediction value). Although it is not depicted in FIG. 2, in-loop filtering can be performed on a reconstructed picture after the picture is reconstructed by obtaining the reconstructed sample 216 for a picture. Subsequently, the reconstructed picture 216 can be stored in the picture buffer to decode a next picture or can be outputted for display.

A video encoding/decoding process requires very high complexity for software/hardware (SW/HW) processing. Hence, in order to perform a job of high complexity using a limited resource, it is able to process a picture (or video) in a manner of partitioning it by a basic processing unit that is a minimum processing unit. Thus, one slice may include at least one basic processing unit. In this case, a basic processing unit included in one picture or slice may have a same size.

In case of HEVC (High Efficiency Video Coding) standard (ISO/IEC 23008-2 or ITU-T H.265), as described above, a basic processing unit may be referred to as CTB (Coding Tree Block) or CTU (Coding Tree Unit) and have a size of 64×64 pixels. Hence, in case of the HEVC standard, a single picture can be encoded/decoded in a manner of being divided by CTU that is a basic processing unit. For detailed example, in case of encoding/decoding 8192×4096 picture, it is able to perform an encoding procedure shown in FIG. 1 or a decoding procedure shown in FIG. 2 on 8,192 CTUs resulting from dividing a picture into the 8,192 CTUs (=128×64).

A video signal or bitstream may include a sequence parameter set (SPS), a picture parameter set (PPS), at least one access unit. The sequence parameter set includes parameter information (of pictures) in a sequence level, and the parameter information of the sequence parameter set may be applied to pictures included in a sequence of pictures. The picture parameter set includes parameter information in a picture level, and information of the picture parameter set may be applied to each slice included in a picture. The access unit refers to a unit corresponding to one picture, and may include at least one slice. A slice may include an integer number of CTUs. Syntax information refers to data included in a bitstream, and a syntax structure refers to a structure of syntax information which is present in a bistream in a specific order.

A size of a coding tree block may be determined using parameter information of SPS. The SPS may include first information indicating the minimum size of a coding block and second information indicating a difference between the minimum size of the coding block and the maximum size of the coding block. In the present specification, the first information may be referred to as log 2_min_luma_coding_block_size_minus3, and the second information may be referred to as log 2_diff_max_min_luma_coding_block_size. Generally, the size of a block may be represented by a power of 2, and thus each information may be represented as a log 2 value of an actual value. Thus, a log 2 value of the minimum size of the coding block may be obtained by adding a specific offset (e.g. 3) to a value of the first information, and a log 2 value of the size of a coding tree block may be obtained by adding a value of the second information to a log 2 value of the minimum size of the coding block. The size of the coding tree block may be obtained by left shifting 1 by the log 2 value. The second information indicating a difference between the minimum size and the maximum size may represent a maximum number of times for partitioning for coding blocks within a coding tree block. Or, the second information may represent a maximum depth of a coding tree within a coding tree block.

Specifically, assuming that a value of the first information (e.g. log 2_min_luma_coding_block_size_minus3) among parameter information of SPS is n, and a value of the second information (e.g. log 2_diff_max_min_luma_coding_block_size) is m, the minimum size N×N of the coding block may be determined to be N=1<<(n+3), and the size M×M of the coding tree block may be determined to be M=1<<(n+m+3) or N<<m. Further, the maximum number of allowed partitioning times for the coding block or the maximum depth of the coding tree within the coding tree block may be determined to be m.

For example, assuming that the size of the coding tree block is 64×64 and the maximum depth of the coding tree within the coding tree block is 3, the coding tree block may be partitioned up to 3 times using a coding tree scheme, and the minimum size of the coding block may be 8×8. Thus, the first information (e.g. log 2_min_luma_coding_block_size_minus3) among parameter information of SPS may have a value of 0, and the second information (e.g. log 2_diff_max_min_luma_coding_block_size) may have a value 3.

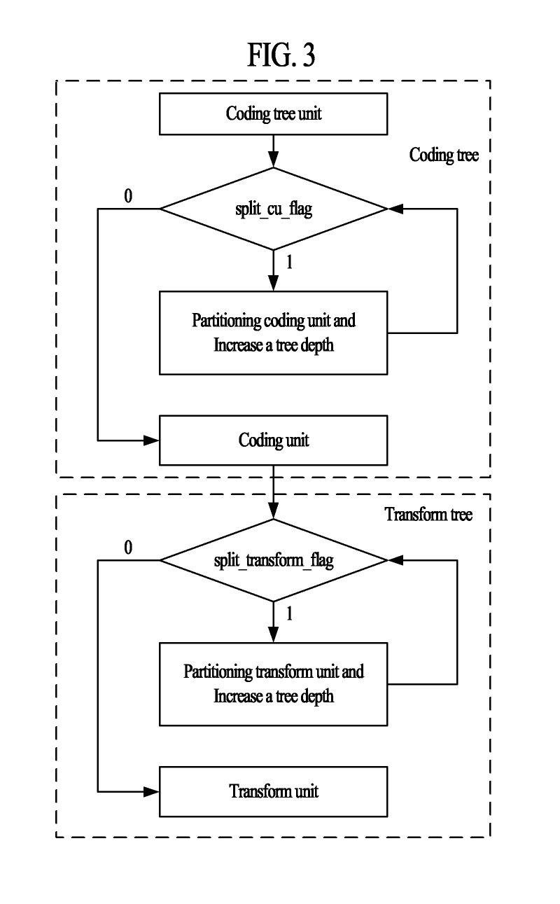

FIG. 3 illustrates a flow chart for a method of partitioning a coding tree block (CTB).

In the HEVC standard, unlike the existing video coding standards (e.g., VC-1, AVC), for the compression efficiency enhancement, after partitioning CTB into at least one coding block (CB) by a quadtree scheme, an intra or inter prediction mode can be determined for a coding block. If CTB is not partitioned, the CTB may correspond to a CB. In this case, the CB may have the same size of the CTB, and an intra or inter prediction mode can be determined for the corresponding CTB.

When a CTB is partitioned by a quadtree scheme, it may be partitioned recursively. After a CTB has been partitioned into 4 blocks, each of the blocks may be partitioned again into subblocks by a quadtree scheme in addition. Each block finally generated by recursively partitioning a CTB by a quadtree scheme may become a coding block. For example, after a CTB has been partitioned into first to fourth blocks, if the first block is partitioned into fifth to eighth blocks but the second to fourth blocks are not partitioned, the second to eighth blocks can be determined as coding blocks. In this example, an intra or inter prediction mode may be determined for each of the second to eighth blocks.

Whether a CTB is partitioned into a coding block may be determined by an encoder side in consideration of RD (rate distortion) efficiency, and information indicating a presence or non-presence of partition may be included in a bitstream. For example, information indicating whether a CTB or a coding block is partitioned into a coding block having a half horizontal/vertical size may be referred to as split_cu_flag in HEVC standard. Information indicating whether a block is partitioned within a CTB may be called a partition indication information for a coding block. A decoder side determines whether to partition a coding block by obtaining information indicating a presence or non-presence of partition for each coding block within a coding quadtree from a bitstream and is able to partition the coding block recursively by a quadtree scheme. A coding tree or coding quad tree refers to a tree structure of coding blocks formed by recursively partitioning a CTB. If each coding block is not partitioned anymore within a coding tree, the corresponding block may be finally referred to as a coding block.

As described above, a coding block can be partitioned into at least one prediction block to perform a prediction. Moreover, a coding block can be partitioned into at least one transform block to perform a transformation. In a manner similar to that of a CTB, a coding block may be recursively partitioned into a transform block by a quadtree scheme. A structure formed by partitioning a coding block by a quadtree scheme may be called a transform tree or a transform quad tree, and information indicating whether each block is partitioned within a transform tree may be included in a bitstream, which is similar to the partition indication information. For example, information indicating whether a block is partitioned into a unit having a half horizontal/vertical size for a transformation in HEVC standard may be called split_transform_flag. Information indicating whether each block is partitioned in a transform tree may be called partition indication information for a transform block.

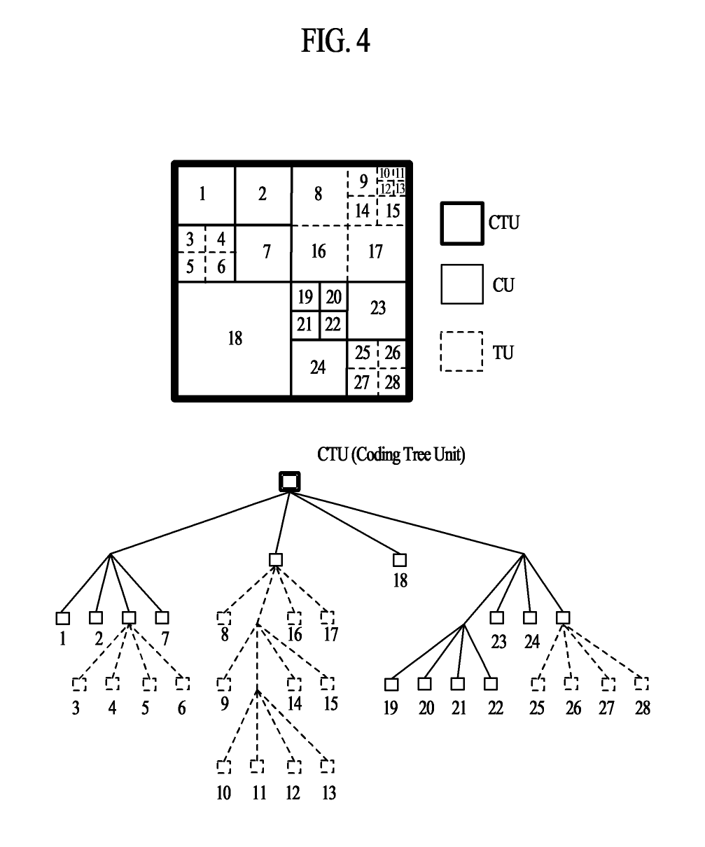

FIG. 4 illustrates an example of partitioning a CTB by a quadtree scheme.

Referring to FIG. 4, a CTB may be partitioned into a first coding block containing blocks 1 to 7, a second coding block containing blocks 8 to 17, a third coding block corresponding to a block 18, and a fourth coding block containing blocks 19 to 28. The first coding block may be partitioned into a coding block corresponding to the block 1, a coding block corresponding to the block 2, a fifth coding block containing the blocks 3 to 6, and a coding block corresponding to the block 7. The second coding block may be partitioned into additional transform blocks for transformation despite failing to be further partitioned within a coding quadtree. The fourth coding block may be partitioned into a sixth coding block containing the blocks 19 to 22, a coding block corresponding to the block 23, a coding block corresponding to the block 24, and a seventh coding block containing the blocks 25 to 28. The sixth coding block may be partitioned into a coding block corresponding to the block 19, a coding block corresponding to the block 20, a coding block corresponding to the block 21, and a coding block corresponding to the block 22. And, the seventh coding block may be partitioned into additional transform blocks for transformation despite failing to be further partitioned within a coding quadtree.

As described above, information (e.g., split_cu_flag) indicating a presence or non-presence of partition for a CTB or each coding block may be included in a bitstream. If the information indicating a presence or non-presence of partition has a first value (e.g., 1), the CTB or each coding block can be partitioned. If the information indicating a presence or non-presence of partition has a second value (e.g., 0), the CTB or each coding block is not partitioned. And, a value of the information indicating a presence or non-presence of partition may vary.

In the example shown in FIG. 4, the partition indication information (e.g., split_cu_flag) for the CTB, the first coding block, the fourth coding block and the sixth coding block may have the first value (e.g., 1). A decoder obtains partition indication information on the corresponding block from the bitstream and is then able to partition the corresponding unit into 4 subunits. On the other hand, the partition indication information (e.g., split_cu_flag) for other coding blocks (coding blocks corresponding to block 1, block 2, block 7, blocks 18 to 23, and blocks 3 to 6, coding blocks corresponding to blocks 8 to 17, and coding blocks corresponding to blocks 25 to 28) may have the second value (e.g., 0). The decoder obtains the partition indication information on the corresponding unit from the bitstream and does not further partition the corresponding unit according to this value.

As described above, each coding block may be partitioned into at least one transform block by a quadtree scheme according to partition indication information for a transform block for transformation. Referring now to FIG. 4, since a coding block corresponding to the blocks 1, 2, 7 and 18 to 24 is not partitioned for transformation, a transform block may correspond to a coding block but another coding block (a coding block corresponding to the blocks 3 and 4, 8 to 17, or 25 to 28) may be additionally partitioned for transformation. Partition indication information (e.g., split_transform_flag) for each unit within a transform tree formed from each coding block (e.g., a coding block corresponding to the blocks 3, 4, 8 to 17, or 25 to 28) and the corresponding coding block can be partitioned into a transform block according to a value of the partition indication information. As shown in FIG. 4 exemplarily, a coding block corresponding to the blocks 3 to 6 may be partitioned into transform blocks to form a transform tree of depth 1, a coding block corresponding to the blocks 8 to 17 may be partitioned into transform blocks to form a transform tree having depth 3, and a coding block corresponding to the blocks 25 to 28 may be partitioned into transform blocks to form a transform tree having depth 1.

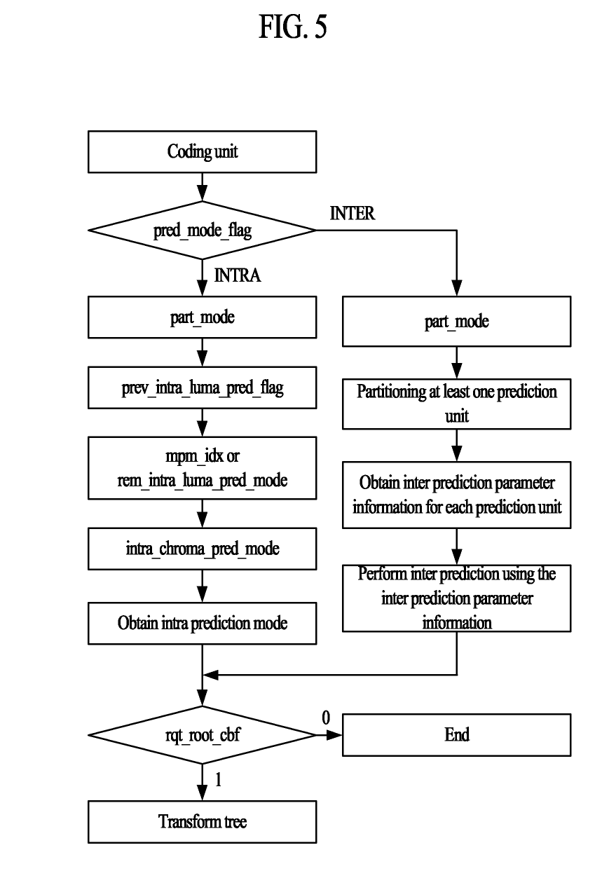

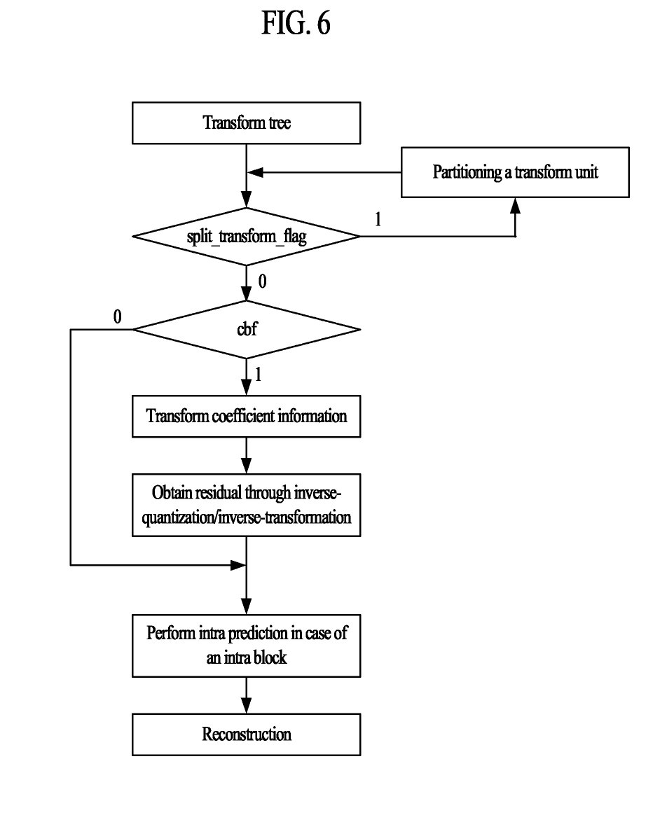

FIG. 5 shows one example of syntax information and operations for a coding block, and FIG. 6 shows one example of syntax information and operations for a transform tree. As exemplarily shown in FIG. 5, information indicating whether a transform tree structure of a current coding block exists can be signaled through a bitstream. In the present specification, such information may be called transform tree coding indication information or rgt_root_cbf. A decoder obtains the transform tree coding indication information from the bitstream. If the transform tree coding indication information indicates that a transform tree for a corresponding coding block exists, the decoder can perform the operation shown in FIG. 6. If the transform tree coding indication information indicates that the transform tree for the corresponding coding block does not exist, transform coefficient information for the corresponding coding block does not exist and the coding block can be reconstructed using a prediction value (intra or inter prediction value) for the corresponding coding block.

A coding block is a basic unit for determining whether it is coded in intra or inter prediction mode. Hence, prediction mode information for each coding block can be signaled through a bitstream. The prediction mode information may indicate whether the corresponding coding block is coded using an intra prediction mode or an inter prediction mode.

If the prediction mode information indicates that the corresponding coding block is coded in the intra prediction mode, informations used in determining the intra prediction mode can be signaled through the bitstream. For example, the information used in determining the intra prediction mode may include intra prediction mode reference information. The intra prediction mode reference information indicates whether an intra prediction mode of a current coding block is derived from a neighbor (prediction) unit, and may be referred to as prev_intra_luma_pred_flag for example.

If the intra prediction mode reference information indicates whether the intra prediction mode of the current coding block is derived from the neighbor (prediction) unit, an intra prediction mode candidate list is constructed using an intra prediction mode of the neighbor unit and index information indicating an intra prediction mode of the current unit in the configured candidate list can be signaled through the bitstream. For example, index information indicating a candidate intra prediction ode used as the intra prediction mode of the current unit in the intra prediction mode candidate list may be referred to as mpm_idx. The decoder obtains the intra prediction mode reference information from the bitstream and may obtain the index information from the bitstream based on the obtained intra prediction mode reference information. Moreover, the decoder may set the intra prediction mode candidate indicated by the obtained index information as the intra prediction mode of the current unit.

If the intra prediction mode reference information does not indicate that the intra prediction mode of the current coding block is not derived from the neighbor unit, information indicating the intra prediction mode of the current unit can be signaled through the bitstream. The information signaled through the bitstream may be referred to as rem_intra_luma_pred_mode for example. The information obtained from the bitstream is compared with values of candidates in the intra prediction mode candidate list. If the obtained information is equal to or greater than the values, the intra prediction mode of the current unit can be obtained by an operation of increment by a specific value (e.g., 1).

If a picture contains a chroma component (or color difference component), information indicating an intra prediction mode for a chroma coding block may be signaled through a bitstream. For example, information indicating a chroma intra prediction mode can be referred to as intra_chroma_pred_mode. The chroma intra prediction mode can be obtained based on Table 1 using the information indicating the chroma intra prediction mode and the intra prediction mode obtained as described above (or the luma intra prediction mod). In Table 1, IntraPredModeY indicates the luma intra prediction mode.

TABLE 1

| | IntraPredModeY | | | | |
|---|---|---|---|---|---|
| intra_chroma_pred_mode | 0 | 26 | 10 | 1 | X(0 <= X <= 34) |
| 0 | 34 | 0 | 0 | 0 | 0 |
| 1 | 26 | 34 | 26 | 26 | 26 |
| 2 | 10 | 10 | 34 | 10 | 10 |
| 3 | 1 | 1 | 1 | 34 | 1 |
| 4 | 0 | 26 | 10 | 1 | X |

An intra prediction mode indicates various prediction odes according to values. A value of an intra prediction mode may correspond to an intra prediction mode, as shown in Table 2, through the aforementioned process.

TABLE 2

| Intra prediction mode | Associated name |
|---|---|
| 0 | INTRA_PLANAR |
| 1 | INTRA_DC |
| 2 . . . 34 | INTRA_ANGULAR2 . . . |
| | INTRA_ANGULAR34 |

In Table 2, INTRA_PLANAR indicates a planar prediction mode and also indicates a mode for obtaining a prediction value of a current block by performing an interpolation on a reconstructed sample of an upper neighbor block adjacent to a current block, a reconstructed sample of a left neighbor block, a reconstructed sample of a lower-left neighbor block, and a reconstructed sample of a right-upper neighbor block. INTRA_DC indicates a DC (Direct Current) prediction mode, and also indicates a mode for obtaining a prediction value of a current block using averages of the reconstructed samples of left neighbor block and the reconstructed samples of upper neighbor block. INTRA_ANGULAR2 to INTRA_ANGULAR34 indicate angular prediction mode, and also indicate a mode for finding a prediction value of a current sample using a reconstructed sample of a neighbor block located in a direction of a specific angle for a current sample within a current block. If a real sample fails to exist in the direction of the specific angle, it is able to find a prediction value in a manner of generating a virtual sample for the corresponding direction by performing an interpolation on neighbor reconstructed samples.

An intra prediction mode may be found per coding block. Yet, intra prediction may be performed by a unit of a transform block. Hence, the aforementioned reconstructed sample of the neighbor block may refer to a reconstructed sample existing within a neighbor block of a current transform block. After finding a prediction value for a current block using an intra prediction mode, it is able to find a difference between the sample value of the current block and the prediction value. The difference between the sample value of the current block and the prediction value may be referred to as a residual (or residual information or residual data). A decoder side obtains transform coefficient information on the current block from a bitstream and is then able to find a residual by performing dequantization and inverse transform on the obtained transform coefficient information. Dequantization may refer to scaling a value of transform coefficient information using a quantization parameter (QP). Since a transform block is a basic unit for performing a transform, transform coefficient information can be signaled through a bitstream by a unit of the transform block.

In case of performing an intra prediction, a residual may be 0. For example, if a sample of a current block is identical to a reference sample for intra prediction, a value of a residual may be 0. If a residual value for a current block is 0 all, since a value of transform coefficient information is 0 all, it is not necessary to signal the transform coefficient information through a bitstream. Hence, information indicating whether transform coefficient information for a corresponding block is signaled through a bitstream can be signaled through a bitstream. Information indicating whether a corresponding transform block has transform coefficient information that is not 0 refers to coded block indication information or coded block flag information, and may be referred to as cbf in the present specification. Coded block indication information for a luma component may be referred to as cbf_luma and coded block indication information for a chroma component may be referred to as cbf_cr or cbf_cb. The decoder obtains coded block indication information for a corresponding transform block from a bitstream. If the coded block indication information indicates that the corresponding block contains transform coefficient information that is not 0, the decoder obtains the transform coefficient information for the corresponding transform block from the bitstream and is also able to obtain a residual through dequantization and inverse transform.

If a current coding block is coded in intra prediction mode, the decoder finds a prediction value for the current coding block by finding a prediction value by transform block unit and/or may find a residual for the current coding block by finding a residual by transform block unit. The decoder can reconstruct the current coding block using the prediction value and/or residual for the current coding block.

As a transform/inverse transform scheme, a discrete cosine transform (DCT) is used popularly. Transform bases for DCT may be approximated in integer form for small memory and fast operation. Transform bases approximated into integers can be represented as a matrix form. And, the transform bases represented in matrix form may be referred to as a transform matrix. In the H.265/HEVC standard, integer transforms in 4×4 to 32×32 sizes are used and a 4×4 or 32×32 transform matrix is provided. The 4×4 transform matrix may be used for 4×4 transform/inverse transform, and the 32×32 transform matrix may be used for 8×8, 16×16, or 32×32 transform/inverse transform.

Meanwhile, if prediction mode information for a current coding block indicates that a current coding block is coded using inter prediction, information indicating a partitioning mode of the current coded coding can be signaled through a bitstream. The information indicating the partitioning mode of the current coding block may be represented as part mode for example. If the current coding block is coded using inter prediction, the current coding block can be partitioned into at least one prediction block according to the partitioning mode of the current coding block.

For example, assuming that a current coding block is 2N×2N block, partitioning modes may include PART_2N×2N, PART_2N×N, PART_N×2N, PART_2N×nU, PART_2N×nD, PART_nL×2N, PART_nR×2N, and PART_N×N. PART_2N×2N indicates a mode that a current coding block is equal to a prediction block. PART_2N×N indicates a mode that a current coding block is partitioned into 2 2N×N prediction blocks. PART_N×2N indicates that a current coding block is partitioned into 2 N×2N prediction blocks. PART_2N×nU indicates a mode that a current coding block is partitioned into an upper 2N×n prediction block and a lower 2N×(N−n) prediction block. PART_2N×nD indicates a mode that a current coding block is partitioned into an upper 2N×(N−n) prediction block and a lower 2N×n prediction block. PART_nL×2N indicates a mode that a current coding block is partitioned into a left n×2N prediction block and a right (N−n)×2N prediction block. PART_nR×2N indicates a mode that a current coding block is partitioned into a left (N−n)×2N prediction block and a right n×2N prediction block. PART_N×N indicates a mode that a current coding block is partitioned into 4 N×N prediction blocks. For example, n is N/2.

Even if a current coding block is in intra coding mode, part mode can be signaled through a bitstream. Yet, when a current coding block is in intra coding mode, only if a size of the current coding block is a minimum size of a coding block, part mode is signaled. And, it is able to indicate whether the current coding block is additionally partitioned into 4 blocks.

A prediction unit is a unit for performing motion estimation and motion compensation. Hence, inter prediction parameter information can be signaled through a bitstream by a unit of a prediction unit. The inter prediction parameter information may include reference picture information, motion vector information and the like for example. The inter prediction parameter information may be derived from a neighbor unit or signaled through a bitstream. A case of deriving the inter prediction parameter information from the neighbor unit is referred to as a merge mode. Hence, information indicating whether inter prediction parameter information for a current prediction unit is derived from a neighbor unit can be signaled through a bitstream. And, the corresponding information may refer to merge indication information or merge flag information. The merge indication information may be represented as merge_flag.

If a merge indication mode indicates that inter prediction parameter information of a current prediction unit is derived from a neighbor unit, a merge candidate list is constructed using the neighbor unit, information indicating a merge candidate to derive the inter prediction parameter information of the current unit in the merge candidate list can be signaled through a bitstream, and the corresponding information may be referred to as merge index information. For example, the merge index information may be represented as merge_idx. Neighbor blocks may include spatial neighbor blocks including a left neighbor block adjacent to a current block, an upper neighbor block, an upper-left neighbor block, a lower-left neighbor block, and an upper-right neighbor block in a picture including the current block and a temporal neighbor block located (or co-located) at a position corresponding to the current block in a picture different from the picture including the current block. The decoder may construct a merge candidate list using the neighbor blocks, obtain merge index information from the bitstream, and set inter prediction parameter information of a neighbor block indicated by the merge index information in the merge candidate list as inter prediction parameter information of the current block.

Meanwhile, when a prediction block corresponds to a coding block, as a result of performing inter prediction on the prediction block, if inter prediction information is identical to a specific neighbor block and residual is 0 all, it is not necessary to signal the inter prediction parameter information, transform coefficient information and the like through a bitstream. In this case, since the inter prediction parameter information for a coding block can be just derived from a neighbor block, a merge mode is applicable. Hence, in case that a corresponding coding block is coded using inter prediction, only merge index information can be signaled through a bitstream for the corresponding coding block. Such a mode is referred to as a merge skip mode. Namely, in the merge skip mode, syntax information for a coded lock is not signaled except merge index information (e.g., merge_idx). Yet, in order to indicate that it is unnecessary to further obtain syntax information except the merge index information (e.g., merge_idx) for the corresponding coding block, skip flag information may be signaled through a bitstream. In the present specification, the skip flag information may be referred to as cu_skip_flag. The decoder obtains skip flag information for the coding block from a slice not in intra coding mode and is able to reconstruct the coding block in the merge skip mode according to the skip flag information.

If a merge indication mode does not indicate that inter prediction parameter information of a current prediction block is derived from a neighbor block, an inter prediction parameter of a current prediction block may be signaled through a bitstream. Reference index information for a reference picture list 0 and/or reference index information for a reference picture list 1 can be signaled through a bitstream depending on whether it is L0 and/or L1 prediction of the current prediction block. Regarding motion vector information, information indicating a motion vector difference and information indicating a motion vector prediction value (predictor) can be signaled through a bitstream. The information indicating the motion vector predictor is index information indicating a candidate used as a motion vector prediction value of a current block in a motion vector predictor candidate list constructed with motion vectors of neighbor blocks, and may be referred to as motion vector predictor indication information. The motion vector predictor indication information may be represented as mvp_10_flag or mvp_11_flag for example. The decoder obtains a motion vector predictor based on motion vector predictor indication information, finds a motion vector difference by obtaining information related to a motion vector difference from a bitstream, and is able to find motion vector information for a current block using the motion vector predictor and the motion vector difference.

If a current coding block is coded using inter prediction, the identical/similar principle may apply to a transform block except that inter prediction is performed by a prediction block unit. Hence, in case of coding a current coding block using inter prediction, the current coding block is partitioned into at least one transform block by a quadtree scheme, transform coefficient information is obtained based on coded block indication information (e.g., cbf_luma, cbf_cb, cbf_cr) for each partitioned transform block, and a residual can be obtained by performing dequantization and inverse transform on the obtained transform coefficient information.

In case that a current coding block is coded in intra prediction mode, the decoder finds a prediction value for the current coding block by finding a prediction value by prediction block unit and/or is able to find a residual for the current coding block by finding a residual by transform block unit. The decoder can reconstruct the current coding block using the prediction value and/or residual for the current coding block.

As described above, according to HEVC, one image (or picture) is divided into a prescribed size of CTBs for video signal processing. In addition, a CTB is divided into at least one coding block based on a quadtree scheme. To improve prediction efficiency of the coding block, each coding block is divided into various sizes and types of prediction blocks, and prediction is performed in each prediction block.

In the case of an inter prediction mode, two adjacent blocks may belong to different coding blocks due to a coding block partition method based on the quadtree scheme. However, even though two adjacent blocks are processed as different coding blocks, at least part of a pixel or sub-block located at block boundaries may be continuous with texture of the other adjacent block. Accordingly, an actual motion vector for the pixel or sub-block located at the block boundaries may be equal to a motion vector of the adjacent block, and thus, a prediction error can be reduced by applying the motion vector of the adjacent block to the corresponding pixel or sub-block. For example, since the pixel or sub-block located at the boundaries of the two adjacent blocks may configure the texture of the other adjacent block rather than that of the other corresponding block, in the case of the pixel or sub-block located at the boundary of the corresponding block, it may be more efficient to perform inter prediction or motion compensation by applying the motion vector of the other adjacent block.

In addition, if motion vectors for adjacent coding blocks or prediction blocks are different from each other, there may be discontinuity in reference blocks indicated by the motion vectors. Moreover, when motion vectors of two adjacent blocks are different from each other, predictors of the corresponding blocks are discontinuous, and thus a prediction error at block boundaries may increase. Although the two adjacent blocks have continuity in an original image, continuity may not be maintained between two reference blocks due to the different motion vectors. Considering the fact that a predictor, which is obtained by performing the inter prediction, is obtained based on a difference between an original image and a reference block, discontinuity between predictors for the two adjacent blocks may be increased. If the discontinuity between the predictors is increased due to the inter prediction, the prediction error at the boundaries of the two adjacent blocks may be significantly increase, and it may cause a blocking artifact. Further, since as the prediction error increases, a residual value increases and frequently occurs. The number of bits for residual data also increases, and it may degrade coding efficiency.

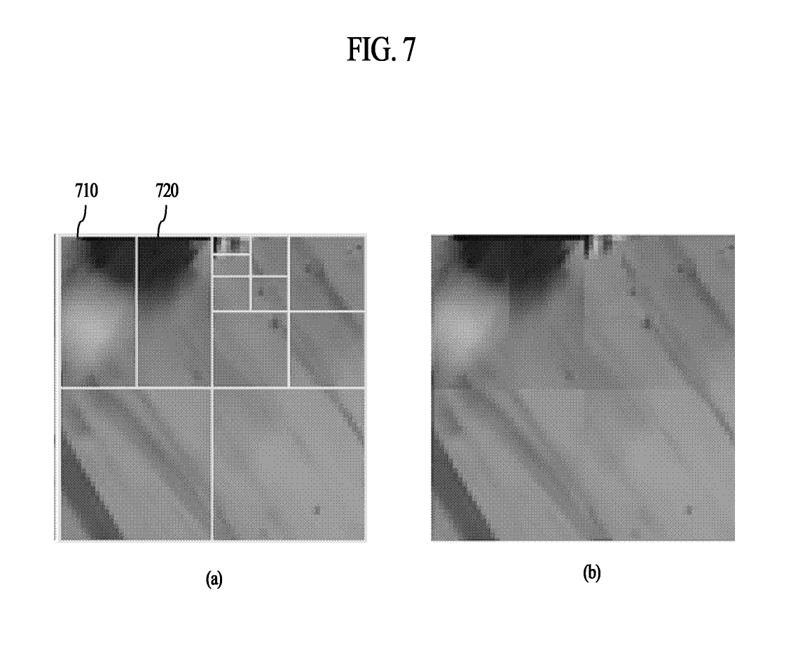

FIG. 7 illustrates boundaries of prediction blocks and samples restored using inter prediction. Specifically, FIG. 7 (a) shows the boundaries of the prediction blocks formed such that a partial picture is divided into coding blocks based on the quadtree scheme and each of the coding blocks is divided into at least one prediction block, and FIG. 7 (b) shows the restored samples except the boundaries of the prediction blocks.

Referring to FIG. 7 (a), the prediction blocks may have various sizes and types according to coding tree depths and partitioning modes of the coding blocks. It can be seen that although prediction blocks 710 and 720 are adjacent to each other, texture of the respective blocks are not continuous. It could be interpreted to mean that different motion vectors are applied due to motion estimation and compensation performed in each prediction block so that a prediction error at boundaries of prediction blocks is increased as described above.

Referring to FIG. 7 (b), it can be checked that the boundaries of the prediction blocks are present due to a blocking artifact (although the boundaries of the prediction blocks are not shown in the drawing). That is, a prediction error is significantly increased at the boundaries between the prediction blocks.

To solve such a problem, the present invention proposes a method for reducing a prediction error and a residual value at a block boundary in consideration of a motion vector or predictor of a neighboring block. In this specification, a coding block and a prediction block are abbreviated as a CB and a PB, respectively.

Proposed Method 1

As described above, adjacent blocks may be processed as different CBs due to the CB partition method based on the quadtree scheme. An actual motion vector for a pixel or sub-block located at block boundaries may be equal to a motion vector of an adjacent block, and thus, it may be efficient to apply the motion vector of the adjacent block to the corresponding pixel or sub-block. In the case of a PB, a motion vector of a current block may be different from that of a neighboring block. In this case, to obtain an accurate predictor for a pixel or sub-block at a boundary of the current block adjacent to the neighboring block, the motion vector of the neighboring block can also be used.

The present invention proposes to generate a new predictor by applying a weighted sum between a predictor obtained by applying a motion vector of a block adjacent to a specific area (e.g., boundary area) of a current block and a predictor obtained by applying a motion vector of the current block. Particularly, a first predictor for the current block (e.g., CB or PB) (or the specific area of the current block) can be obtained based on the motion vector of the current block, and a second predictor for the specific area of the current block can be obtained based on the motion vector of a neighboring block adjacent to the specific area. Subsequently, the weighted sum is obtained by applying a weight to the first predictor and/or the second predictor. Thereafter, a predictor for the current block can be obtained by setting the obtained weighted sum as a predictor for the specific area or based on the obtained weighted sum.

In this case, different weights can be applied to the first and second predictors. When the same weight is applied, the weighted sum may be an average of the two predictors. For example, the specific area of the current block may include the pixel or sub-block located at the boundary of the current block. In addition, for example, the sub-block may have a size of 2×2, 4×4, or more.

When the new predictor proposed in the present invention is used, coding efficiency of residual data can be improved. Particularly, according to the present invention, when the motion vectors of the two adjacent blocks are different from each other, the predictor in accordance with the motion vector of the neighboring block is applied to the specific area (e.g., boundary area) of the current block, thereby reducing a prediction error at the specific area of the current block. In addition, according to the present invention, it is possible to reduce not only a blocking artifact at the specific area of the block but also residual data, and thus, coding efficiency can be remarkably improved.

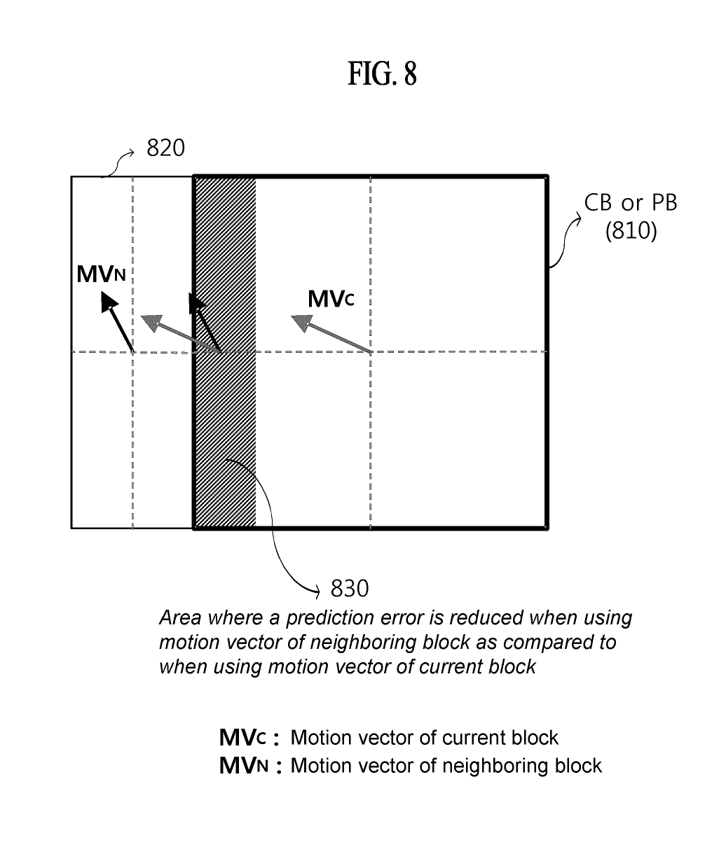

FIG. 8 illustrates an inter prediction method according to the present invention.

Referring to FIG. 8, a current block 810 may correspond to a CB or a PB, MV_{C} indicates a motion vector of the current block, and MV_{N} indicates a motion vector of a neighboring block 820 adjacent to the current block. When the motion vector of the neighboring block 820 rather than the moving vector of the current block 810 is applied to a specific area 830 of the current block, prediction performance can be improved, and a prediction error can be reduced. In the example of FIG. 8, the specific area 830 of the current block may include a pixel or sub-block located at a specific boundary of the current block.

According to the proposed method 1 of the present invention, a first predictor for the current block 810 (or the specific area 830) can be obtained based on the motion vector of the current block, MV_{C}, and a second predictor for the specific area 830 of the current block 810 can be obtained based on the motion vector of the neighboring block 820, MV_{N}. Based on a weighted sum of the first and second predictors, a predictor for the specific area 830 of the current block 810 or a predictor for the current block 810 can be obtained. For example, the predictor for the specific area 830 of the current block 810 may be replaced with or set as the weighted sum of the first and second predictors.

Regarding the proposed method 1 of the present invention, the following items are additionally proposed:
A candidate neighboring block having a motion vector for a specific area (e.g., boundary area) of a current block (cf. proposed method 1-1 of the present invention);
A predictor ranges where a weighting factor will be applied (cf. proposed method 1-2 of the present invention);
A weight or weighting factor (cf. proposed method 1-3 of the present invention); and
A signaling method (cf. proposed method 1-4 of the present invention).

Proposed Method 1-1 (Candidate Neighboring Block Selection)

A neighboring block having a motion vector capable of reducing a prediction error at a specific area (e.g., boundary area) of a current block may include a CB/PB that is available or spatially adjacent to the current block, a sub-block of the CB/PB, or a representative block of the CB/PB. In addition, the neighboring block according to the present invention may include a CB/PB that is available or temporally adjacent to the current block, a sub-block of the CB/PB, or a representative block of the CB/PB. The number of neighboring blocks for the current block may be a single or plural. Alternatively, a combination of multiple neighboring blocks may be used.

In this specification, a neighboring block (spatially) adjacent to the current block within a picture including the current block can be referred to as a spatial neighboring block. In addition, a block located at a position corresponding to that of the current block within a picture different from that including the current block or a neighboring block temporally adjacent to the current block can be referred to as a temporal neighboring block. The available neighboring block (for the inter prediction) may imply that the corresponding block (CB or PB) is present in the picture including the current block, exists in the same slice or tile as that of the current block, and is coded in the inter prediction mode. Here, the tile may mean a rectangular area including at least one CTB or unit in a picture, and the representative block may mean a block having a representative value (e.g., median value, average value, minimum value, majority value, etc.) of motion vectors of multiple blocks or a block where the representative value is applied.

For example, the neighboring block having the motion vector for the specific area (e.g., boundary area) of the current block may be determined according one of the following (1-1-a) to (1-1-e).

(1-1-a) In the case of MERGE/SKIP, a candidate, a representative candidate, multiple candidates, or a combination of multiple candidates may be selected from among merge candidates. Here, MERGE may indicate the above-described aggregation mode, and SKIP may indicate the above-described aggregation skip mode.

(1-1-b) In the case of AMVP, a candidate, a representative candidate, multiple candidates, or a combination of multiple candidates may be selected from among AMVP candidates. The AMVP (Advanced Motion Vector Prediction) may indicate a mode of signaling a motion vector predictor using the above-described motion vector predictor indication information.

(1-1-c) In the case of TMVP, a representative, multiple ones, or a combination of multiple ones may be selected in consideration of colPU or a neighboring block of the colPU. The colPU may indicate a (prediction) block located at the position corresponding to that of the current block within a picture different from that including the current block, and the TMVP (Temporal Motion Vector Prediction) may indicate a mode of performing motion vector prediction using the colPU.

(1-1-d) Without consideration of a mode of the current block (e.g., MERGE/SKIP, AMVP, TMVP, etc.), a candidate, a representative candidate, multiple candidates, or a combination of multiple candidates may be selected from among neighboring or available blocks. For example, a neighboring block may be a spatial neighboring block located at an opposite side of the specific area of the current block with respect to a specific boundary of the current block.

(1-1-e) A combination of the aforementioned methods (i.e., (1-1-1) to (1-1-d)) may be used.

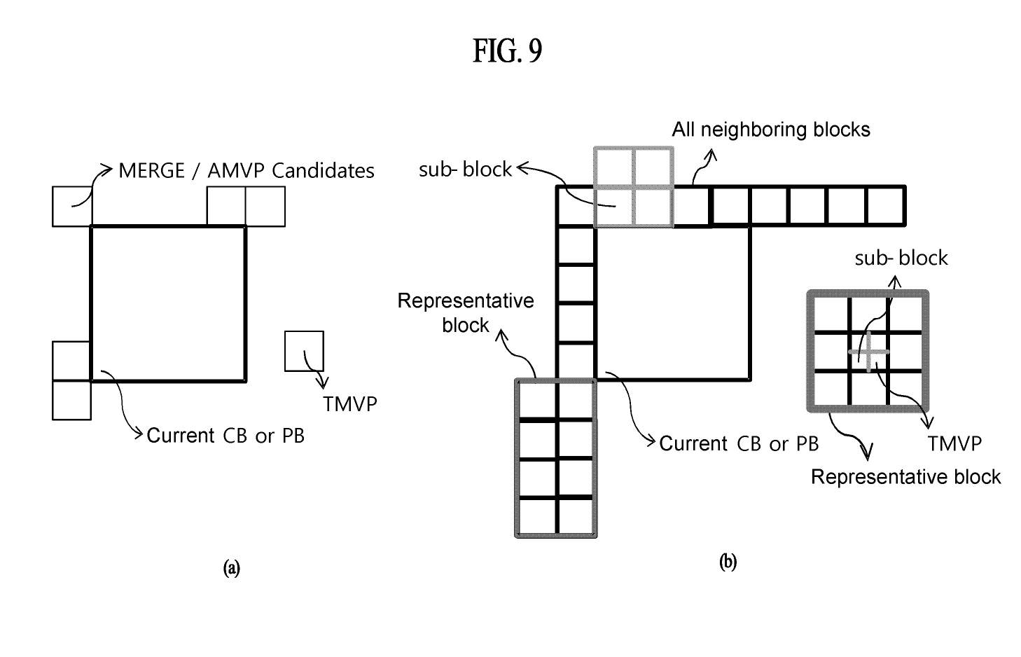

FIG. 9 illustrates neighboring blocks according to the present invention. Specifically, FIG. 9(a) shows neighboring blocks in accordance with (1-1-a) to (1-1-c), and FIG. 9(b) shows neighboring blocks in accordance with (1-1-d).

Referring to FIG. 9(a), the neighboring blocks according to the present invention may include at least one among spatial neighboring blocks such as a left neighboring block, an upper neighboring block, a left upper neighboring block, a left lower neighboring block, and a right upper neighboring block, which are adjacent to a current block, within a picture including the current block (CB or PB) and temporal neighboring blocks located (or co-located) at a position corresponding to that of the current block within a picture different from the picture including the current block or a combination of at least two among them.

Referring to FIG. 9(b), the neighboring block according to the present invention may include at least one among all sub-blocks or representative blocks temporally and/or spatially adjacent to the current block or a combination of at least two among them.

Proposed Method 1-2 (Area where Weighted Sum is Applied)

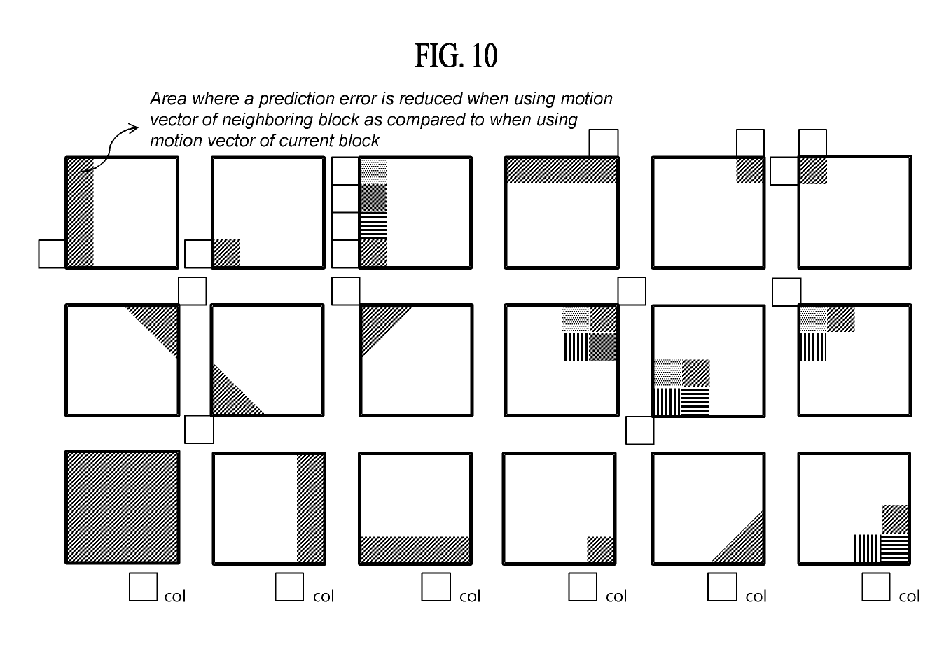

As a specific area (e.g., boundary area) of a current block is closer to a neighboring block, a prediction error that occurs when a predictor obtained from a motion vector of the neighboring block is used may be reduced. That is, an area where the prediction error is reduced may be changed according to a position of the neighboring block. For example, a relationship between the specific area of the current block and the neighboring block can be depicted as shown in FIG. 10. A weighted sum may be applied to the area where the prediction error is expected to be reduced, and the corresponding area may include a pixel or block.

In this specification, the area where the weighted sum is applied according to the present invention within the current block can be referred to as a specific area according to the present invention. Thus, the specific area according to the present invention means an area of which a predictor is calculated using a weighted sum of a predictor obtained by applying a motion vector of the current block to the corresponding area within the current block according to the proposed method 1 of the present invention and a predictor obtained by applying a motion vector of the neighboring block to the corresponding area.

Referring to FIG. 10, when the neighboring block is a (spatial) left neighboring block, the specific area according to the present invention may include a pixel or sub-block located at a left boundary of a current block. As a non-limited example, when the neighboring block according to the present invention is the (spatial) left neighboring block, the specific area according to the present invention may include the pixel or at least one block with a size of 2×2, 4×4, or more, all of which are located at the left boundary (cf. the example in the first row and the first column of FIG. 10). As another non-limited example, when the neighboring block according to the present invention is the (spatial) left neighboring block, the specific area according to the present invention may be configured to be adjacent to the neighboring block and have the same height as the neighboring block (cf. the example in the first row and the second column of FIG. 10). In this case, the specific area may have a width of 1, 2, 4 or more pixels. As a further non-limited example, when the neighboring block according to the present invention includes all sub-blocks, the specific area according to the present invention may be configured to be adjacent to the neighboring block and have the same height or width as the neighboring block (cf. the example in the first row and the third column of FIG. 10). In this case, the specific area may have a width or height of 1, 2, 4, or more pixels. In addition, in this example, it is possible to calculate a weighted sum or an average value by applying a motion vector of the adjacent neighboring block to the corresponding block.

When the neighboring block is a (spatial) upper neighboring block adjacent to the current block, the specific area according to the present invention a pixel or at least one block located at an upper boundary of the current block. As a non-limited example, when the neighboring block according to the present invention is the (spatial) upper neighboring block, the specific area according to the present invention may include the pixel or at least one block with a size of 2×2, 4×4, or more, all of which are located at the upper boundary (cf. the example in the first row and the fourth column of FIG. 10). As another non-limited example, when the neighboring block according to the present invention is the (spatial) upper neighboring block, the specific area according to the present invention may be configured to be adjacent to the neighboring block and have the same height as the neighboring block (cf. the example in the first row and the fifth column of FIG. 10). In this case, the specific area may have a width of 1, 2, 4 or more pixels.

When the neighboring block includes the (spatial) upper neighboring block and left neighboring block which are adjacent to the current block, the specific area according to the present invention may include a block with at a horizontal coordinate corresponding to that of the upper neighboring block and a vertical coordinate corresponding to that of the left neighboring block. In addition, it may also include the pixel or at least one block located at the upper boundary of the current block. As a non-limited example, when the neighboring block according to the present invention includes, among neighboring sub-blocks, a left-most neighboring block among upper neighboring blocks and an upper-most neighboring block among left neighboring blocks, the specific area according to the present invention may be a left upper corner block with a width and height corresponding to that of the neighboring blocks (cf. the example in the first row and sixth column of FIG. 10). In this case, it is possible to obtain a predictor of the specific area such that a weighted sum of predictors is calculated by applying motion vectors of the left-most neighboring block and the upper-most neighboring block to the specific area.

When the neighboring block is a (spatial) right upper neighboring block adjacent to the current block, the specific area according to the present invention may include a pixel or at least one block located at the upper boundary of the current block. As a non-limited example, when the neighboring block is the (spatial) right upper neighboring block, the specific area according to the present invention may include a pixel or triangular block located at a right upper corner (cf., the example in the second row and the first column of FIG. 10). In this case, one side of the triangular block may include 2, 4, or more pixels. As another non-limited example, when the neighboring block according to the present invention is the (spatial) right upper neighboring block, the specific area according to the present invention may include a plurality of pixels (e.g., four pixels) or sub-blocks located at the right upper corner (cf. the example in the second row and the fourth column of FIG. 10). In this case, it may include a plurality of blocks having sizes of 2×2, 4×4, or more, and different weights may be applied to the plurality of pixels or blocks, respectively.

When the neighboring block is a (spatial) left lower neighboring block adjacent to the current block, the same/similar principles can be applied (cf., the example in the second row and the second column of FIG. 10 and the example in the second row and the fifth column of FIG. 10). When the neighboring block is a (spatial) left upper neighboring block adjacent to the current block, the same/similar principle can also be applied (cf., the example in the second row and third column of FIG. 10 and the example in the second row and the sixth column of FIG. 10).

When the neighboring block is a (temporal) neighboring block adjacent to the current block, the specific area according to the present invention may include the entirety of the current block (cf. the example in the third row and first column of FIG. 10) or at least one pixel or block located at a specific boundary of the current block. As a non-limited example, when the neighboring block is the (temporal) neighboring block, the specific area according to the present invention may include a pixel or sub-blocks located at a right boundary of the current block (cf., the example in the third row and the second column of FIG. 10), pixel or sub-blocks located at a lower boundary of the current block (cf. the example in the third row and the third column of FIG. 10), a pixel or sub-block located at a right lower corner of the current block (cf. the example in the third row and the fourth column of FIG. 10 and the example in the third row and the fifth column of FIG. 10), or a plurality of pixels (e.g., three or four pixels) or sub-blocks located at a right lower corner of the current block (cf. the example in the third row and the sixth column of FIG. 10). Each sub-block may have a height or width of 2, 4, or more pixels. One side of the triangular block may include 2, 4, or more pixels. In addition, when the specific area includes a plurality of pixels or blocks, different weights may be applied to the plurality of pixels or blocks, respectively.

The specific area according to the present invention (or a pixel or block where the weighted sum will be applied) may be changed according to characteristics of the current block and neighboring block. For example, a size of the current block, a size of the neighboring block, a prediction mode of the current block, a difference between a motion vector of the current block and a motion vector of the neighboring block, or whether there is a real edge with respect to boundaries of the current and neighboring blocks may be considered as the block characteristics.

When the neighboring block is large, the neighboring block may have a small effect on the boundaries of the current block and thus, it may become one standard for determining an area where the weighted sum will be applied. In case a mode of the current block is MERGE (or aggregation mode), if the neighboring block is determined as an aggregation candidate, the weighted sum may not be applied due to the same motion vector. In addition, as the difference between the motion vector of the current block and the motion vector of the neighboring block increases, discontinuity may increase at the boundaries. However, in this case, the discontinuity at the boundaries may occur due to the real edge, it should be considered.

For example, the block characteristics can be reflected based on at least one of (1-2-a) to (1-2-j).

(1-2-a) The area where the weighted sum is applied can be changed in consideration of sizes of the current and neighboring block as shown in Table 3.

TABLE 3

| Size of | Size of | Area where weighted sum is applied |
|---|---|---|
| surrounding | current | (when surrounding block is located |
| block | block | at left of current block) |
| >32 × 32 | 64 × 64 | 2 × 64 |
| >32 × 32 | 32 × 32 | 2 × 32 |
| >32 × 32 | 16 × 16 | 1 × 16 |
| >32 × 32 | 8 × 8 | 1 × 8 |
| <=32 × 32 | 64 × 64 | 4 × 64 |
| <=32 × 32 | 32 × 32 | 4 × 32 |
| <=32 × 32 | 16 × 16 | 3 × 16 |
| <=32 × 32 | 8 × 8 | 2 × 8 |

(1-2-b) When the motion vector of the current block is different from that of the neighboring block, the weighted sum is applied.

(1-2-c) When the difference between the motion vectors of the current and neighboring blocks is greater than a threshold, the area where the weighted sum will be applied is increased.

(1-2-d) When reference pictures are different (e.g., a case in which picture order counts (POCs) of the reference pictures are different) even though the difference between the motion vectors of the current and neighboring blocks is smaller than the threshold, the weighted sum is not applied. In this case, if the difference between the motion vectors of the current and neighboring blocks is smaller than the threshold and the reference pictures are the same (e.g., a case in which POCs of the reference pictures are the same), the weighted sum can be applied.

(1-2-e) When the difference between the motion vectors of the current and neighboring blocks is greater than the threshold, the weighted sum is not applied.

(1-2-f) When the difference between the motion vectors of the current and neighboring blocks is greater than the threshold, the weighted sum is not applied based on the determination that it is caused by the real edge.

(1-2-g) When the neighboring block is an intra-CU/PU, the weighted sum is not applied.

(1-2-h) When the neighboring block is an intra-CU/PU, the weighted sum is applied by assuming that there is no movement (i.e., zero motion and zero refldx).

(1-2-i) When the neighboring block operates in an intra mode, the area where the weighted sum will be applied is determined by considering directivity of an intra-prediction mode.

(1-2-j) The area where the weighted sum will be applied can be determined based on combinations of the above-described conditions.

Proposed Method 1-3 (Weight)

According to the present invention, a predictor obtained from a motion vector of a neighboring block and a predictor obtained from a motion vector of a current block are weigh-summed as described above. In this case, an area where a weighting factor will be applied may be a pixel or block, and the same or different weight may be applied to each pixel or block.

For example, the same weight may be applied to a first predictor obtained by applying the motion vector of the current block to the specific area according to the present invention and a second predictor obtained by applying the motion vector of the neighboring block. In this case, the weighted sum may correspond to an average of the first and second predictors. As another example, the same weight may be applied to each sample of the first predictor for the specific area according to the present invention, and the same weight may be applied to each sample of the second predictor. However, in this case, the weight for the first predictor may be different from that for the second predictor. As a further example, the weight may be applied to the first predictor for the specific area according to the present invention on a pixel basis or a block basis independently and/or differently, and the weight may be applied to the second predictor on the pixel basis or block basis dependently and/or differently. In this case, the weight for the first predictor may be equal to or different from that for the second predictor.

Meanwhile, as a pixel or block is closer to the neighboring block, a higher weight is applied to the predictor obtained based on the motion vector of the neighboring block in order to improve coding efficiency. That is, according to the present invention, as the pixel or block is closer to the neighboring block, the higher weight is applied to the predictor obtained based on the motion vector of the neighboring block, compared to the predictor obtained based on the motion vector of the current block. For example, compared to the pixel and block close to the neighboring block, in the case of a pixel or block far away from the neighboring block, the weight may be configured such that the first predictor is reflected more than the second predictor. Alternatively, for example, the weight may be configured such that a ratio between the weight for the first predictor for the pixel or block close to the neighboring block and the weight for the second predictor is greater than a ratio between the weight for the first predictor for the pixel or block far away from the neighboring block and the weight for the second predictor.

In this case, the weight for the first predictor may be configured/applied independently and/or differently on the pixel basis or block basis, and the weight for the second predictor may also be configured/applied independently and/or differently on the pixel basis or block basis. Similarly, in this case, the weight for the first predictor may be equal to or different from the that for the second predictor. In addition, for the predictor obtained by applying the motion vector of the current block, a lower weight may be applied as the pixel or block is closer to the neighboring block (or boundary). Alternatively, a higher weight may be applied as the pixel or block is closer to the neighboring block (or boundary).

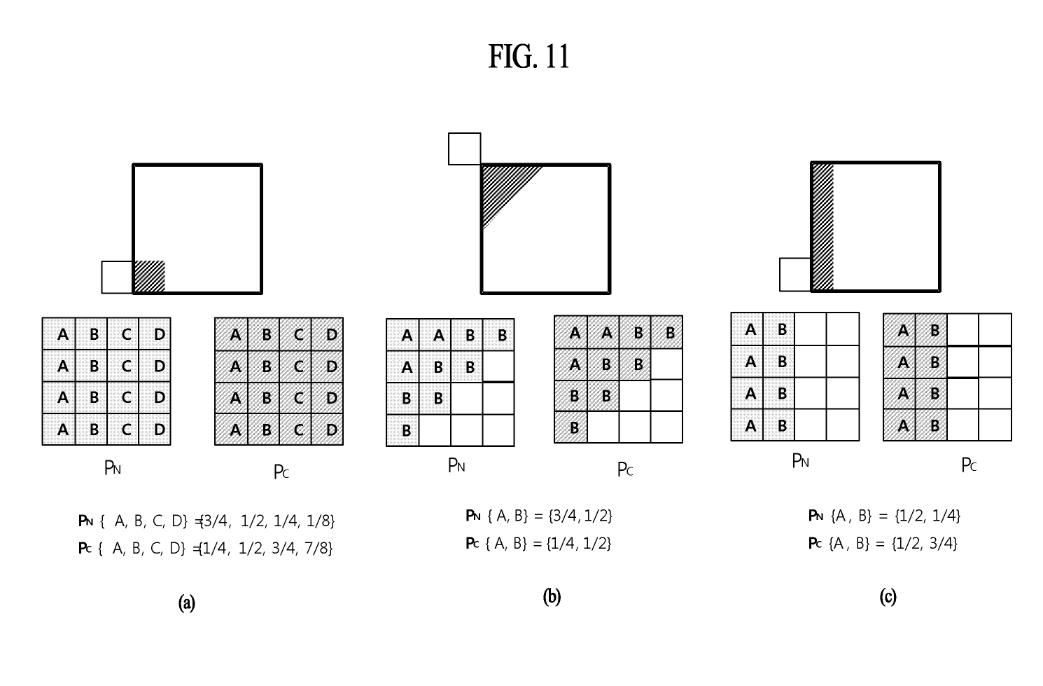

FIG. 11 illustrates weights according to the present invention. As illustrated in FIG. 11, various weights can be applied according to positions of the neighboring block and the area where the weighted sum is applied. Although FIG. 11 shows an example in which the neighboring block is a left neighboring block or a right upper block, the principles that will be described with reference to FIG. 11 can be applied to other examples (cf. the examples of FIG. 10) in the same/similar manner. In addition, although in the example of FIG. 11, each of the neighboring block and the specific area according to the present invention is assumed to be a 4×4 block, the present invention is not limited thereto. Moreover, the invention can be similarly/equally applied when each of the neighboring block and the specific area according to the present invention is a block or pixel with a different size. In FIG. 11, P_{N} indicates a predictor obtained by applying a motion vector of the neighboring block to the specific area according to the present invention, and P_{C} indicates a predictor obtained by applying a motion vector of the current block.

Referring to FIG. 11(a), the neighboring block is a (spatial) left neighboring block, and the specific area according to the present invention is a left lower corner pixel or block. In addition, for a first predictor (e.g., P_{N}) obtained by applying a motion vector of the neighboring block to the area according to the present invention, as a pixel is closer to the neighboring block (or boundary), a higher weight may be applied (e.g., A>B>C>D).

In addition, in the example of FIG. 11(a), in the case of the pixel close to the neighboring block (or boundary) within the area according to the present invention, a weight for the first predictor (e.g., P_{N}) obtained by applying the motion vector of the neighboring block may be configured to be higher than that for a second predictor (e.g., P_{C}) obtained by applying the motion vector of the current block. More particularly, in the case of a pixel (e.g., A) closest to the neighboring block (or boundary), the weights for the first and second predictors may be configured such that the first predictor (e.g., P_{N}) is reflected more than the second predictor (e.g., P_{C}), compared to other pixels (e.g., B, C, and D). Thus, a ratio (e.g., 3/4:1/4=3:1 or 3) between the weight for the first predictor and the weight for the second predictor in the case of the pixel (e.g., A) closest to the neighboring block (or boundary) may be configured to be higher than a ratio (e.g., 1/8:7:8=1:7 or 1/7) between the weight for the first predictor and the weight for the second predictor in the case of a pixel (e.g., D) far away from the neighboring block (or boundary).

Referring to FIG. 11 (b), the neighboring block is a (spatial) left upper neighboring block, and the specific area according to the present invention is a left upper corner pixel or block. Thus, for a first predictor (e.g., P_{N}) obtained by applying a motion vector of the neighboring block to the area according to the present invention, a higher weight (e.g., A>B) may be applied as a pixel is closer to the left upper corner of the current block.

In addition, in the example of FIG. 11(b), in the case of the pixel close to the left upper corner within the area according to the present invention, a weight for the first predictor (e.g., P_{N}) obtained by applying the motion vector of the neighboring block may be configured to be relatively higher than that for a second predictor (e.g., P_{C}) obtained by applying the motion vector of the current block. More particularly, in the case of the pixel (e.g., A) close to the left upper corner, the weights for the first and second predictors may be configured such that the first predictor (e.g., P_{N}) is reflected more than the second predictor (e.g., P_{C}), compared to another pixel (e.g., B). Thus, a ratio (e.g., 3/4:1/4=3:1 or 3) between the weight for the first predictor and the weight for the second predictor in the case of the pixel (e.g., A) close to the left upper corner may be configured to be higher than a ratio (e.g., 1/2:1/2=1:1 or 1) between the weight for the first predictor and the weight for the second predictor in the case of a pixel (e.g., B) far away from the left upper corner.

Referring to FIG. 11(c), the basic structure is similar to that of FIG. 11(a), but the specific area according to the present invention is a block adjacent to a left boundary and its width corresponds to two pixels. Similarly, in this case, for a first predictor (e.g., P_{N}) obtained by applying a motion vector of the neighboring block, a higher weight (e.g., A>B) may be applied as a pixel is closer to the left boundary.

In addition, in the example of FIG. 11(c), in the case of a pixel (e.g., A) close to the neighboring block (or boundary), weights for the first and second predictors may be configured such that the first predictor (e.g., P_{N}) is reflected more than the second predictor (e.g., P_{C}), compared to another pixel (e.g., B). Thus, a ratio (e.g., 1/2:1/2=1:1 or 1) between the weight for the first predictor and the weight for the second predictor in the case of the pixel (e.g., A) close to the neighboring block (or boundary) may be configured to be higher than a ratio (e.g., 1/4:3/4=1:3 or 1/3) between the weight for the first predictor and the weight for the second predictor in the case of a pixel (e.g., B) far away from the neighboring block (or boundary).

The weight value, the position of the neighboring block, and the area where the weighted sum is applied in the example of FIG. 11 are merely exemplary, and the present invention is not limited thereto.

Proposed Method 1-4 (Signaling Method)

To apply a weighted sum to a predictor obtained based on a motion vector of a neighboring block and a predictor obtained based on a motion vector of a current block, whether the weighted sum is used and whether the weighted sum is applied on a pixel basis or block basis can be signaled.

Information indicating whether the weighted sum is used can be signaled through at least one of methods (1-4-a) to (1-4-f). For example, the information indicating whether the weighted sum is used may be referred to as information indicating the use of the weighted sum or flag information on the use of the weighted sum. When the information indicating the use of the weighted sum has a value of 1, it may indicate that the weighted sum is used. On the contrary, when the information has a value of 0, it may indicate that the weighted sum is not used. This is a merely example, and the information indicating the use of the weighted sum according to the present invention can be referred to as other names. Moreover, its value may be set in the opposite way or in the different manner.

(1-4-a) The information indicating whether the weighted sum is used between predictors may be signaled through a sequence parameter set (SPS). The information signaled through the SPS may be applied to all sequences included in pictures.

(1-4-b) The information indicating whether the weighted sum is used between predictors may be signaled through a picture parameter set (PPS). The information signaled through the PPS may be applied to a picture where the PPS is applied.

(1-4-c) The information indicating whether the weighted sum is used between predictors may be signaled through an adaptation parameter set (APS). The information signaled through the APS may be applied to a picture where the APS is applied.

(1-4-d) The information indicating whether the weighted sum is used between predictors may be signaled through a slice header. The information signaled through the slice header may be applied to the corresponding slice header.

(1-4-e) The information indicating whether the weighted sum is used between predictors may be signaled through a coding unit (CU). The information signaled through the CU may be applied to the corresponding CU.

(1-4-f) The information indicating whether the weighted sum is used between predictors may be signaled through a prediction unit (PU). The information signaled through the PU may be applied to the corresponding PU.

Syntax information may be present in a bitstream in the following order: SPS, PPS, APS, slice header, CU, and PU. Thus, when whether the weighted sum is used is signaled through a plurality of methods among (1-4-a) to (1-4-f), information signaled through low-level syntax may be overridden with the corresponding level and other lower levels and then applied. For example, when whether the weighted sum is used is signaled through the SPS, the corresponding indication information indicates that the weighted sum is not used, whether the weighted sum is used is signaled through the slice header, and the corresponding indication information indicates that the weighted sum is used, the weighted sum is used only for a slice corresponding to the slice header. That is, the weighted sum is not used for other remaining slices and pictures except the corresponding slice.

Information indicating whether the weighted sum is applied on the pixel basis or block basis can be signaled through at least one of methods (1-4-g) to (1-4-1) or cannot be signaled. For example, the information indicating whether the weighted sum is applied on the pixel basis or block basis may be referred to as information indicating a unit for applying the weighted sum or flag information on a unit for applying the weighted sum. When the information has a value of 0, it may indicate that the weighted sum is applied on the pixel basis. On the contrary, when the information has a value of 1, it may indicate that the weighted sum is applied on the block basis. This is a merely example, and values of the information indicating the unit for applying the weighted sum be set in the opposite way or in the different manner.

(1-4-g) The information indicating whether the area where the weighted sum is applied is the pixel or block may be signaled through the SPS. The information signaled through the SPS may be applied to all sequences included in pictures.

(1-4-h) The information indicating whether the area where the weighted sum is applied is the pixel or block may be signaled through the PPS. The information signaled through the PPS may be applied to a picture where the PPS is applied.

(1-4-i) The information indicating whether the area where the weighted sum is applied is the pixel or block may be signaled through the APS. The information signaled through the APS may be applied to a picture where the APS is applied.

(1-4-j) The information indicating whether the area where the weighted sum is applied is the pixel or block may be signaled through the slice header. The information signaled through the slice header may be applied to the corresponding slice header.

(1-4-k) The information indicating whether the area where the weighted sum is applied is the pixel or block may be signaled through the CU. The information signaled through the CU may be applied to the corresponding CU.

(1-4-1) The information indicating whether the area where the weighted sum is applied is the pixel or block may be signaled through the PU. The information signaled through the PU may be applied to the corresponding PU.

Similar to the information indicating the use of the weighted sum, when the unit for applying the weighted sum is signaled through a plurality of methods among (1-4-g) to (1-4-1), information signaled through low-level syntax may be overridden with the corresponding level and other lower levels and then applied.

Proposed Method 2

Unlike the CB divided based on the quadtree scheme, the PB can be divided into various forms such as 2N×2N, N×2N, 2N×N, 2N×nU, 2N×nD, nL×2N, and nR×2N according to partitioning mode. In addition, in the case of the PB, when a motion vector of a neighboring block is used, a prediction error may be decreased at a boundary area of a current block due to various partitioning modes. However, since discontinuity may still exist between predictors of adjacent blocks, the prediction error at the boundary area of the block needs to be decreased.

In the proposed method 2 of the present invention, a method for eliminating discontinuity by smoothing a boundary area between predictors of blocks. Particularly, according to the proposed method 2 of the present invention, a predictor of a current block can be smoothed using a predictor of an adjacent block.

In the proposed method 1 of the present invention, a predictor obtained by applying a motion vector of a neighboring vector to a specific area of a current block is used. On the other hand, in the proposed method 2 of the present invention, a predictor obtained by applying a motion vector of a neighboring block to the neighboring block is used. More particularly, the proposed method 2 of the present invention is different from the proposed method 1 of the present invention in that a boundary area of the current block is smoothed using the predictor of the neighboring block. In this case, the predictor of the adjacent block is not obtained by applying the motion vector of the adjacent vector to the specific area of the current block but means the predictor of the adjacent block.

For example, according to the proposed method 2 of the present invention, the specific area of the current block can be smoothed by applying the weighted sum to the predictor of the current block using the predictor of the adjacent block. That is, the proposed method 2 of the present invention can be operated similar to the proposed method 1 of the present invention by applying the predictor of the adjacent block instead of the first predictor, which is obtained by applying the motion vector of the adjacent block to the specific area of the current block according to the proposed method 1.

The following items are additionally proposed for the proposed method 2 of the present invention.
A current block and a candidate neighboring block where a smoothing factor will be applied (cf. proposed method 2-2 of the present invention);
A predictor ranges where a smoothing factor will be applied (cf. proposed method 2-2 of the present invention);
A smoothing factor or smoothing factor coefficient (cf. proposed method 2-3 of the present invention); and
A signaling method (cf. proposed method 2-4 of the present invention).

Proposed Method 2-1 (Candidate Neighboring Block)

According to the proposed method 2-1, a weighted sum can be applied to neighboring adjacent areas having different motion vectors for a predictor of a current block. The neighboring adjacent area may include a CB/PB that is available or spatially adjacent to the current block, a sub-block of the CB/PB, or a representative block of the CB/PB. In addition, the neighboring block according to the present invention may include a CB/PB that is available or temporally adjacent to the current block, a sub-block of the CB/PB, or a representative block of the CB/PB. The number of neighboring blocks for the current block may be a single or plural. Alternatively, a combination of multiple neighboring blocks may be used.

For example, the neighboring block where smoothing will be applied according to the proposed method 2 of the present invention may be processed in the same/similar manner as the neighboring block in accordance with the proposed method 1-1. Thus, the neighboring block where smoothing will be applied according to the proposed method 2 of the present invention can be determined as described above with reference to (1-1-a) to (1-1-e) and/or FIG. 9.

Proposed Method 2-2 (Area where Smoothing is Applied)

The specific area according to the present invention (or a pixel or block where smoothing will be applied) may be changed according to characteristics of the current block and neighboring block. For example, a prediction mode of the current block, a size of the neighboring block, a prediction mode of the current block, a difference between a motion vector of the current block and a motion vector of the neighboring block, or whether there is a real edge with respect to boundaries of the current and neighboring blocks may be considered as the block characteristics.

In case a mode of the current block is MERGE (or aggregation mode), if the neighboring block is determined as an aggregation candidate, smoothing may not be applied due to the same motion vector. In addition, as the difference between the motion vector of the current block and the motion vector of the neighboring block increases, discontinuity may increase at the boundaries. However, in this case, the discontinuity at the boundaries may occur due to the real edge, it should be considered.

For example, the block characteristics can be reflected based on at least one of (2-2-a) to (2-2-i).

(2-2-a) When the motion vector of the current block is different from that of the neighboring block, smoothing is applied.

(2-2-b) When the difference between the motion vectors of the current and neighboring blocks is greater than a threshold, the area where smoothing will be applied is increased.

(2-2-c) When reference pictures are different (e.g., a case in which picture order counts (POCs) of the reference pictures are different) even though the difference between the motion vectors of the current and neighboring blocks is smaller than the threshold, smoothing is not applied. In this case, if the difference between the motion vectors of the current and neighboring blocks is smaller than the threshold and the reference pictures are the same (e.g., a case in which POCs of the reference pictures are the same), smoothing can be applied.

(2-2-d) When the difference between the motion vectors of the current and neighboring blocks is greater than the threshold, smoothing is not applied.

(2-2-e) When the difference between the motion vectors of the current and neighboring blocks is greater than the threshold, smoothing is not applied based on the determination that it is caused by the real edge.

(2-2-f) When the neighboring block is an intra-CU/PU, smoothing is not applied.

(2-2-g) When the neighboring block is an intra-CU/PU, smoothing is applied by assuming that there is no movement (i.e., zero motion and zero refldx).

(2-2-h) When the neighboring block operates in an intra mode, the area where smoothing will be applied is determined by considering directivity of an intra-prediction mode.

(2-2-i) The area where smoothing will be applied can be determined based on combinations of the above-described conditions.

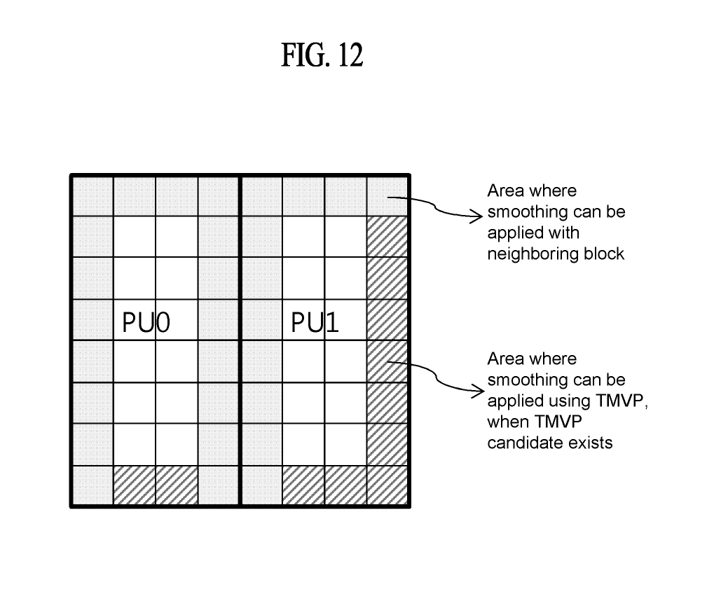

FIG. 12 illustrates areas where smoothing is applied. Although FIG. 12 shows a case in which a single CB is divided into two PB (e.g., PU0 and PU1) (e.g., an N×2N partitioning mode), the present invention is not limited thereto and can be equally/similarly applied to other partitioning modes. In addition, each quadrangle illustrated in FIG. 12 may correspond to a pixel, a 2×2 block, a 4×4 block, or a larger block.

Referring to FIG. 12, in a pixel or block located at left or right boundaries of the CB, smoothing can be performed using a predictor of a neighboring block spatially adjacent to the current CB. In addition, in a pixel or block located at inner boundaries (e.g., boundaries of PU0 and PU1) of the CB, smoothing can be performed using a predictor of a spatially adjacent block (e.g., a pixel or block of PU1 for PU0 or a pixel or block of PU0 for PU1).

Meanwhile, at the remaining boundaries of the CB except the above-described boundaries, smoothing can be performed using a predictor of a block temporally adjacent to the current block (e.g., a TMVP candidate, or a block located at a position corresponding to that of the current block within a picture different from that including the current block). For example, in a pixel or block located at a lower boundary of the CB and/or a right boundary of the CB, smoothing can be performed using the predictor of the block temporally adjacent to the current block.

Proposed Method 2-3 (Smoothing Factor)

According to the present invention, a predictor of a neighboring block and a predictor obtained from a motion vector of a current block are smoothed. An area where smoothing will be applied may be a pixel or block, and an identical or different smoothing factor can be applied to each pixel or block. The smoothing factor according to the present invention can be configured as described above with reference to the proposed method 1-3.

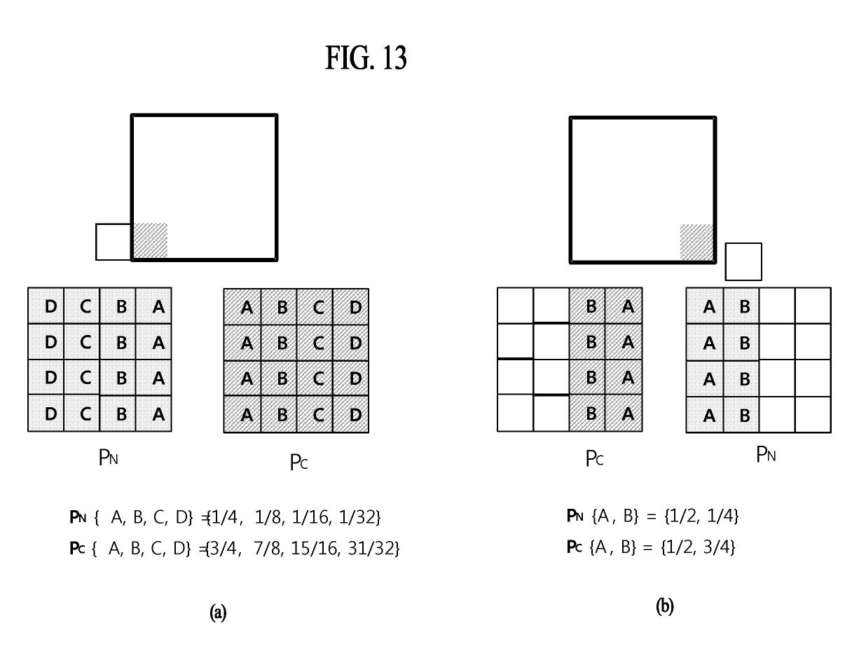

FIG. 13 illustrates smoothing factors according to the present invention. As illustrated in FIG. 13, various smoothing factors can be applied according to positions of the neighboring block and the area where smoothing is applied. Although FIG. 13 shows an example in which the neighboring block is a left neighboring block or a right upper block, the principles that will be described with reference to FIG. 13 can be applied to other examples (cf. the examples of FIG. 10) in the same/similar manner. In addition, although in the example of FIG. 13, each of the neighboring block and the specific area according to the present invention is assumed to be a 4×4 block, the present invention is not limited thereto. Moreover, the invention can be similarly/equally applied when each of the neighboring block and the specific area according to the present invention is a block or pixel with a different size. In FIG. 13, P_{N} indicates a predictor of the neighboring block, and P_{C} indicates a predictor of the current block.

Referring to FIG. 13(a), the neighboring block is a (spatial) left neighboring block, and the specific area according to the present invention is a left lower corner pixel or block. Thus, in the case of a pixel close to the neighboring block (or boundary), a weight for a predictor (e.g., P_{N}) of the neighboring block may be configured to be relatively higher than that for a predictor (e.g., P_{C}) of the current block. More particularly, in the case of a pixel (e.g., A) closest to the neighboring block (or boundary), the weight for the predictor (e.g., P_{N}) of the neighboring block and the weight for the predictor (e.g., P_{C}) of the current block may be configured such that the predictor (e.g., P_{N}) of the neighboring block is reflected more than the predictor (e.g., P_{C}) of the current block, compared to other pixels (e.g., B, C, and D). Thus, a ratio (e.g., 1/4:3/4=1:3 or 1/3) between the weight for the predictor (e.g., P_{N}) of the neighboring block and the weight for the predictor (e.g., P_{C}) of the current block in the case of the pixel (e.g., A) close to the neighboring block (or boundary) may be configured to be higher than a ratio (e.g., 1/32:31/32=1:31 or 1/31) between the weight for the predictor (e.g., P_{N}) of the neighboring block and the weight for the predictor (e.g., P_{C}) of the current block in the case of a pixel (e.g., D) far away from the neighboring block (or boundary).

Alternatively, for the predictor (e.g., P_{N}) of the neighboring block and the predictor (e.g., P_{C}) of the current block, as a pixel is closer to the boundaries, higher weights may be applied (e.g., A>B>C>D).

Referring to FIG. 13 (b), the neighboring block is a (temporal) neighboring block, and the specific area according to the present invention is a right lower corner pixel or block of the current block. Thus, in the case of the pixel (e.g., A) closest to the neighboring block (or boundary), the weight for the predictor (e.g., P_{N}) of the neighboring block and the weight for the predictor (e.g., P_{C}) of the current block may be configured such that the predictor (e.g., P_{N}) of the neighboring block is reflected more than the predictor (e.g., P_{C}) of the current block, compared to another pixel (e.g., B). Thus, a ratio (e.g., 1/2:1/2=1:1 or 1) between the weight for the predictor (e.g., P_{N}) of the neighboring block and the weight for the predictor (e.g., P_{C}) of the current block in the case of the pixel (e.g., A) close to the neighboring block (or boundary) may be configured to be higher than a ratio (e.g., 1/4:3/4=1:3 or 1/3) between the weight for the predictor (e.g., P_{N}) of the neighboring block and the weight for the predictor (e.g., P_{C}) of the current block in the case of the pixel (e.g., B) far away from the neighboring block (or boundary).

Alternatively, for the predictor (e.g., P_{N}) of the neighboring block and the predictor (e.g., P_{C}) of the current block, as a pixel is closer to the boundaries, higher weights may be applied (e.g., A>B).

The smoothing factor value, the position of the neighboring block, and the area where smoothing is applied in the example of FIG. 13 are merely exemplary, and the present invention is not limited thereto.

Proposed Method 2-4 (Signaling Method)

To apply smoothing to a predictor of a neighboring block and a predictor of a current block, whether smoothing is used and whether smoothing is applied on a pixel basis or block basis can be signaled.

As the signaling method, the methods described in the proposed method 1-4 can be equally/similarly applied. For example, information indicating whether smoothing is used may be referred to as information indicating the use of smoothing or flag information on the use of smoothing. The information may be signaled through at least one of the methods (1-4-a) to (1-4-f). Similarly, information indicating whether smoothing is applied on the pixel basis or block basis may be signaled through at least one of the methods (1-4-g) to (1-4-1). Alternatively, the information may not be signaled.

Proposed Method 3

The proposed methods 1 and 2 of the present invention can be applied independently. However, in some cases, the proposed methods 1 and 2 can be applied through a combination thereof.

For example, when a CB is divided into a plurality of PBs, the proposed method 1 may be applied to boundaries of the CB, and the proposed method 2 may be applied to boundaries between the PBs in the CB. By doing so, at the boundaries of the CB, a new predictor can be obtained by applying a weighted sum between a predictor obtained by applying a motion vector of a neighboring block to a specific area of a current block and a predictor of the current block. At the boundaries between the PBs in the CB, the predictor of the current block can be smoothed by applying smoothing to the specific area of the current block using the predictor of the neighboring block.

As a particular example, referring back to FIG. 12, the proposed method 1 of the present invention may be applied to a pixel or block located at the left, upper, lower, or right boundaries of the CB, and the proposed method 2 of the present invention may be applied to the boundaries between the PBs (e.g., a boundary between PU0 and PU1) in the CB.

The proposed methods 1 to 3 according to the present invention can be applied to a process for calculating a predictor through the inter prediction when a current block is coded in the inter prediction mode. More particularly, the proposed methods 1 to 3 according to the present invention may be applied to the step of FIG. 5, where the inter prediction is performed using inter prediction parameter information. In addition, the remaining encoding/decoding processes may be performed as described with reference to FIGS. 1 to 6.

Proposed Method 4

The aforementioned weight and smoothing factor are assumed to have predefined values. However, considering that features of motion and texture can be changed in each image or each specific area of the corresponding image, coding efficiency can be further improved if an optimal weighting window suitable for the image features is calculated by an encoder and then transmitted to a decoder.

Thus, in the proposed method 4 of the present invention, it is proposed to explicitly signal a factor or weight (or smoothing factor) of the weighting window, which will be used in performing a weighted sum, through a bitstream. More particularly, according to the proposed method 1 of the present invention, the weight to be applied to the first predictor obtained by applying the motion vector of the neighboring block and the weight to be applied to the second predictor obtained by applying the motion vector of the current block can be signaled through at least one of the SPS, PPS, slice header, CTU, CU and PU. In this case, the weights of the present invention can be signaled through the bitstream on a sequence basis, picture basis, slice basis, tile basis, CTU basis, CU basis, or PU basis.

According to the proposed method 2 of the present invention, the smoothing factor to be applied to the predictor of the neighboring block and the predictor of the current block can be signaled through at least one of the SPS, PPS, slice header, CTU, CU and PU. In this case, the smoothing factor of the present invention can be signaled through the bitstream on the sequence basis, picture basis, slice basis, tile basis, CTU basis, CU basis, or PU basis.

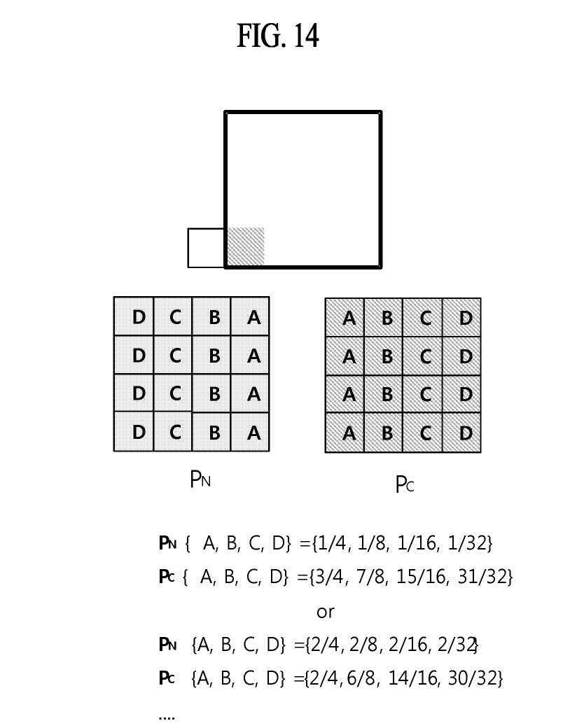

FIG. 14 illustrates weights and smoothing factors according to the present invention.

Referring to FIG. 14, an encoder may transmit values corresponding to P_{N} and P_{C} (e.g., a weight or smoothing factor) which will be used in performing a weighted sum or smoothing in consideration of image features on the sequence basis, picture basis, slice basis, tile basis, CTU basis, CU basis, or PU basis. In the example of FIG. 14, if {1/4, 1/8, 1/16, 1/32}, {2/4, 2/8, 2/16, 2/32}, or one among other sets is signaled for a weight or smoothing factor related to P_{N} through the SPS, PPS, slice header, CTU, CU or PU, a decoder can perform the proposed methods of the present invention by applying the signaled weight set or smoothing factor set. Similarly, if {3/4, 7/8, 15/16, 31/32}, {2/4, 6/8, 14/16, 30/32} or one among other sets is signaled for a weight or smoothing factor related to P_{C} through the SPS, PPS, slice header, CTU, CU or PU, the decoder can perform the proposed methods of the present invention by applying the signaled weight set or smoothing factor set.

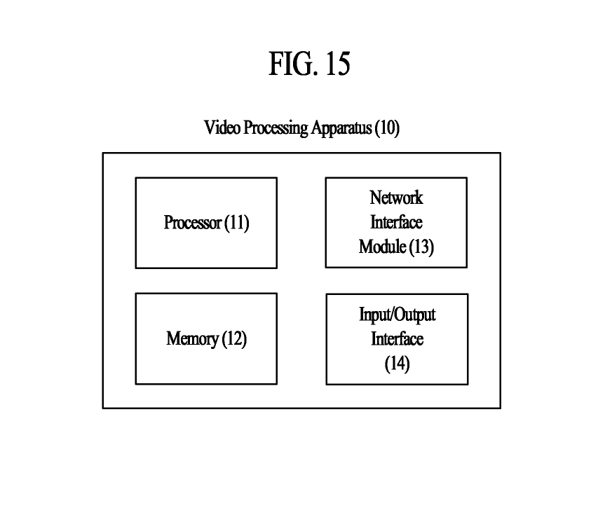

FIG. 15 illustrates a block diagram to which the present invention can be applied. The video processing apparatus may include an encoding apparatus and/or a decoding apparatus of a video signal. For example, the video processing apparatus to which the present invention can be applied may include a mobile terminal such as a smart phone, a mobile equipment such as a laptop computer, a consumer electronics such as a digital TV, a digital video player, and etc.

A memory 12 may store program for processing and controlling by a processor 11, and may store a coded bitstream, a reconstructed image, control information, and the like. Further, the memory 12 may be used as a buffer for various video signals. The memory 12 may be implemented as a storage device such as a ROM (Read Only Memory), RAM (Random Access Memory), EPROM (Erasable Programmable Read Only Memory), EEPROM (Electrically Erasable Programmable Read-Only Memory), a flash memory, SRAM (Static RAM), HDD (Hard Disk Drive), SSD (Solid State Drive), and etc.

The processor 11 controls operations of each module in the video processing apparatus. The processor 11 may perform various control functions to perform encoding/decoding according to the present invention. The processor 11 may be referred to as a controller, a microcontroller, a microprocessor, a microcomputer, or etc. The processor 11 may be implemented as a hardware or a firmware, a software, or a combination thereof. When the present invention is implemented using a hardware, the processor 11 may comprise ASIC (application specific integrated circuit), DSP (digital signal processor), DSPD (digital signal processing device), PLD (programmable logic device), FPGA (field programmable gate array), or the like. Meanwhile, when the present invention is implemented using a firmware or a software, the firmware or software may comprise modules, procedures, or functions that perform functions or operations according to the present invention. The firmware or software configured to perform the present invention may be implemented in the processor 11 or may be stored in the memory 12 and executed by the processor 11.

In addition, the apparatus 10 may optionally include a network interface module (NIM) 13. The network interface module 13 may be operatively connected with the processor 11, and the processor 11 may control the network interface module 13 to transmit or receive wireless/wired signals carrying information, data, a signal, and/or a message through a wireless/wired network. For example, the network interface module 13 may support various communication standards such as IEEE 802 series, 3GPP LTE(-A), Wi-Fi, ATSC (Advanced Television System Committee), DVB (Digital Video Broadcasting), and etc, and may transmit and receive a video signal such as a coded bitstream and/or control information according to the corresponding communication standard. The network interface module 13 may not be included as necessary.

In addition, the apparatus 10 may optionally include an input/output interface 14. The input/output interface 14 may be operatively connected with the processor 11, and the processor 11 may control the input/output interface 14 to input or output a control signal and/or a data signal. For example, the input/output interface 14 may support specifications such as USB (Universal Serial Bus), Bluetooth, NFC (Near Field Communication), serial/parallel interface, DVI (Digital Visual Interface), HDMI (High Definition Multimedia Interface) so as to be connected with input devices such as a keyboard, a mouse, a touchpad, a camera and output devices such as a display.

The embodiments of the present invention described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by a subsequent amendment after the application is filed.

The embodiments of the present invention may be implemented by various means, for example, hardware, firmware, software, or a combination thereof. In a hardware implementation, an embodiment of the present invention may be implemented by one or more application specific integrated circuits (ASICs), digital signal processors (DSPs), digital signal processing devices (DSDPs), programmable logic devices (PLDs), field programmable gate arrays (FPGAs), processors, controllers, microcontrollers, microprocessors, etc.

In a firmware or software implementation, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention can be applied to a video processing apparatus such as a decoding apparatus or an encoding apparatus.

What is claimed is:

1. A method for decoding a bitstream for a video signal by a decoding apparatus, the method comprising:
obtaining a predictor for a current block based on a motion vector of the current block; and
reconstructing the current block based on the predictor for the current block,
wherein when a specific condition is satisfied, obtaining the predictor for the current block includes:
obtaining a first predictor by applying, to an area located at a specific boundary of the current block, a motion vector of a neighboring block adjacent to the area,
obtaining a second predictor by applying the motion vector of the current block to the area, and
obtaining a weighted sum by applying a first weight to the first predictor and applying a second weight to the second predictor.

2. The method of claim 1, wherein when the specific boundary corresponds to a left boundary or an upper boundary of the current block, the first predictor is obtained by applying a motion vector of a spatial neighboring block of the current block, and
wherein when the specific boundary corresponds to a right boundary or a lower boundary of the current block, the first predictor is obtained by applying a motion vector of a temporal neighboring block of the current block.

3. The method of claim 2, wherein the spatial neighboring block corresponds to a neighboring block located at an opposite side of the area with respect to the specific boundary within a picture including the current block, and the temporal neighboring block corresponds to a block located at a position corresponding to the current block within a picture different from the picture including the current block.

4. The method of claim 1, wherein the first weight is configured to have a higher value as closer to the specific boundary, and the second weight is configured to have a lower value as closer to the specific boundary.

5. The method of claim 1, wherein the area corresponds to a 2×2 block or a 4×4 block.

6. The method of claim 1, wherein the specific condition includes a condition that the motion vector of the current block is different from the motion vector of the neighboring block, and a condition that a difference between the motion vector of the current block and the motion vector of the neighboring block is smaller than a threshold and a reference picture of the current block is equal to a reference picture of the neighboring block.

7. The method of claim 1, wherein the method further comprises:
receiving flag information indicating whether prediction using the weighted sum is applied to the current block,
wherein the specific condition includes a condition that the flag information indicates that the prediction using the weighted sum is applied to the current block.

8. A decoding apparatus configured to decode a bitstream for a video signal, the decoding apparatus comprising a processor, wherein the processor is configured to:
obtain a predictor for a current block based on a motion vector of the current block, and
reconstruct the current block based on the predictor for the current block,
wherein when a specific condition is satisfied, obtaining the predictor for the current block includes:
obtaining a first predictor by applying, to an area located at a specific boundary of the current block, a motion vector of a neighboring block adjacent to the area,
obtaining a second predictor by applying the motion vector of the current block to the area, and
obtaining a weighted sum by applying a first weight to the first predictor and applying a second weight to the second predictor.

9. The decoding apparatus of claim 8, wherein when the specific boundary corresponds to a left boundary or an upper boundary of the current block, the first predictor is obtained by applying a motion vector of a spatial neighboring block of the current block, and
wherein when the specific boundary corresponds to a right boundary or a lower boundary of the current block, the first predictor is obtained by applying a motion vector of a temporal neighboring block of the current block.

10. The decoding apparatus of claim 9, wherein the spatial neighboring block corresponds to a neighboring block located at an opposite side of the area with respect to the specific boundary within a picture including the current block, and the temporal neighboring block corresponds to a block located at a position corresponding to that of the current block within a picture different from the picture including the current block.

11. The decoding apparatus of claim 8, wherein the first weight is configured to have a higher value as closer to the specific boundary, and wherein as the neighboring block is closer to the specific boundary, the second weight is configured to have a lower value as closer to the specific boundary.

12. The decoding apparatus of claim 8, wherein the area corresponds to a 2×2 block or a 4×4 block.

13. The decoding apparatus of claim 8, wherein the specific condition includes a condition that the motion vector of the current block is different from the motion vector of the neighboring block, and a condition that a difference between the motion vector of the current block and the motion vector of the neighboring block is smaller than a threshold and a reference picture of the current block is equal to a reference picture of the neighboring block.

14. The decoding apparatus of claim 8, wherein the method further comprises:
receiving flag information indicating whether prediction using the weighted sum is applied to the current block,
wherein the specific condition includes a condition that the flag information indicates that the prediction using the weighted sum is applied to the current block.
